(19) United States
(12) Patent Application Publication
(10) Pub. No.: US 2026/0031870 A1
(43) Pub. Date: Jan. 29, 2026

(54) METHODS, APPARATUSES AND SYSTEMS RELATED TO SUB-ARRAY SELECTION FOR NEAR-FIELD UPLINK

(71) Applicant: InterDigital Patent Holdings, Inc., Wilmington, DE (US)

(72) Inventors: Patrick Svedman, Stockholm (SE); Afshin Haghighat, Ile-Bizard (CA); Allan Yingming Tsai, Boonton, NJ (US); Ravikumar Pragada, Warrington, PA (US); Paul Marinier, Brossard (CA); Salah Elhoushy, LaSalle (CA); Yifan Li, Conshohocken, PA (US); Chia-Hung Wei, Chesterbrook, PA (US)

(21) Appl. No.: 18/783,881

(22) Filed: Jul. 25, 2024

(51) Int. Cl. H04B 7/06; H04B 17/318; H04L 5/00

(52) U.S. Cl. CPC H04B 7/0626; H04B 17/328; H04L 5/0025

(57) ABSTRACT

A method, implemented in a WTRU, comprises receiving a first message comprising configuration information indicating a plurality of DL RS resources, a set of one or more UL RS resources, and a CSI reporting setting; performing one or more measurements on one or more DL RSs; determining a subset of DL RS resources based on the performed one or more measurements; transmitting a CSI report comprising first information indicating the determined subset of DL RS, wherein the CSI report is based on the CSI reporting setting; determining one or more spatial domain filters based on the determined subset of DL RS resources; and transmitting a subset of one or more UL RS resources of the set of one or more UL RS using the determined one or more spatial domain filters.

### FIELD OF THE INVENTION

The present disclosure is generally directed to methods and procedures related to sub-array selection for near-field uplink. More particularly, the present disclosure relates to a method to select sub-array for near field uplink assisted by a wireless transmit/receive unit.

### BACKGROUND

Recently, there is an increase of transmission/reception point (TRP) antenna array aperture and carrier frequency due to development of wireless communication. In such conditions, the classical planar wave approximation may no longer hold in an increasing part of the coverage arca, called the near field. Legacy direction-based “far-field beamforming” may suffer a loss in beamforming gain in the near field. However, in this case, a TRP sub-array could be used to generate a far field condition (in relation to the sub-array aperture).

For a user equipment (UE) in the near field, a first sub-array at one edge of the TRP array may correspond to a first UE receive/transmit (Rx/Tx) beam, while a second sub-array at the other edge of the TRP array may correspond to a second UE Rx/Tx beam that is different from the first. This is due to the larger angle that the TRP array spans from the perspective of the near-field UE, compared to a far-field UE.

It may be beneficial to use a subset of the TRP sub-arrays to serve a UE in the near field. In such a case, the UE signal-to-noise power ratio (SNR) may be high due to small pathloss in the near field, the TRP may turn off remaining sub-arrays, thereby saving network energy, and multi-user multiple input multiple output (MU-MIMO) can be achieved, with the near-field UE served by a first subset of the TRP sub-arrays and a second UE (in the far or near field) can be served by a second subset of TRP sub-arrays.

It may be also beneficial to use dynamic adaptation of the subset of TRP sub-arrays that serve the near-field UE may be beneficial. Accordingly, UE rotation may change the subset of TRP sub-arrays in the main lobe of the UE beam(s), and partial and dynamic shadowing of some TRP sub-arrays (called “non-stationarity” in near field (NF) channel modelling).

Unfortunately, the main scenario considered herein is that a UE is in the near field of a TRP. However, the solutions above may be applicable to other scenarios as well, for example UE-assisted TRP selection or UE-assisted beam selection.

It is assumed that the UE may support some level of beam correspondence, i.e., that a UE can determine an uplink (UL) Tx beam from a DL Rx beam.

Dynamic adaptation could be implemented with existing tools for instance as follows.

In a first solution based on channel state information (CSI) reporting, a UE may be configured with CSI reference signal(s) (CSI-RS), CSI reporting, and sounding reference signal(s) (SRS). A TRP may transmit different CSI-RS from its sub-arrays. The UE may measure the CSI-RS and determines a subset of CSI-RS/sub-arrays. The UE may report the subset (e.g., CSI-RS resource indicator(s) (CRI(s))).

In a second solution based on an update of SRS spatial references and SRS transmission, a UE may receive a downlink control information (DCI) that schedules a physical downlink shared channel (PDSCH). The UE may decode the PDSCH and obtains a medium access control (MAC) control element (CE) that updates the spatial reference(s) of SRS resource(s) to a subset of the CSI-RS/sub-arrays. Few milliseconds after the transmission of the PDSCH acknowledgement (ACK), the UE may update the spatial references of the SRS resource(s), based on the MAC CE. The UE may receive another DCI that triggers transmission of the SRS resources, and the UE may transmit the triggered SRS resources with UL Tx beams towards the subset of sub-arrays.

The problem with the above solutions, based on existing tools, is that it incurs more signaling overhead and higher latency than what is necessary.

There is a need to enable efficient and fast dynamic adaptation of a subset of TRP sub-arrays that a network may use to receive a near-field UE's UL transmissions and the corresponding UE UL Tx beams.

### SUMMARY

In an embodiment, a method, implemented in a wireless transmit/receive unit (WTRU) may comprise a step of receiving a first message comprising configuration information indicating a plurality of downlink reference signal (DL RS) resources, a set of one or more uplink reference signal (UL RS) resources, and a channel state information (CSI) reporting setting. The method may further comprise a step of performing one or more measurements on one or more DL RSs. Performing the one or more measurements may comprise performing any of a DL RS received power (DL RSRP) measurement, and signal to interference and noise power ratio (SINR) on the one or more DL RSs. The method may further comprise a step of determining a subset of DL RS resources based on the performed one or more measurements. The method may further comprise a step of transmitting a CSI report comprising first information indicating the determined subset of DL RS, wherein the CSI report is based on the CSI reporting setting. The CSI report may comprise second information indicating one or more results of the one or more measurements on the one or more DL RSs. The method may further comprise a step of determining one or more spatial domain filters based on the determined subset of DL RS resources; and a step of transmitting a subset of one or more UL RS resources of the set of one or more UL RS using the determined one or more spatial domain filters.

The method may comprise a step of determining the subset of one or more UL RS resources based on the determined subset of DL RS resources. The method may comprise a step of determining the subset of one or more UL RS resources based on the determined one or more spatial domain filters.

The method may comprise a step of receiving a downlink control information (DCI) comprising third information indicating a trigger for CSI reporting, and the transmitting the CSI report is triggered by the DCI. The method may comprise a step of receiving the DCI comprising fourth information indicating a trigger for transmission of the subset of one or more UL RS resources, and the transmitting the subset of one or more UL RS resources is triggered by the DCI.

The method may comprise a step of receiving the DCI comprising scheduling information of a physical uplink shared channel (PUSCH) resource for transmission of the CSI report; and a step of transmitting the CSI report on the scheduled PUSCH resource. The set of one or more UL RS resources may be respectively associated with one or more time offsets, and the scheduling information may comprise a PUSCH transmission time corresponding to (e.g., associated with) the scheduled PUSCH resource, such that the method may comprise a step of determining, based on the one or more time offsets, one or more UL RS transmission times respectively associated with the subset of one or more UL RS resources, wherein determining the one or more UL RS transmission times comprises adding the one or more time offsets to the PUSCH transmission time; and a step of transmitting the subset of one or more UL RS resources in the determined respectively one or more UL RS transmission times using the determined spatial domain filters. The configuration information may further indicate an association between the CSI reporting setting and the set of UL RS resources, such that the method may comprise a step of transmitting the CSI report comprising first information indicating the determined subset of DL RS, wherein the CSI report is based on the associated CSI reporting setting, a step of determining the one or more spatial domain filters based on the determined subset of DL RS resources; and a step of transmitting the subset of one or more UL RS resources of the set of the associated one or more UL RS using the determined one or more spatial domain filters.

The UL RS resources may be sounding reference signal (SRS) resources. The DL RS resources may be channel state information reference signal (CSI-RS) resources.

In an embodiment, a wireless transmit/receive unit (WTRU) comprising a processor, a transmitter, a receiver and a memory, may be configured to receive a first message comprising configuration information indicating a plurality of downlink reference signal (DL RS) resources, a set of one or more uplink reference signal (UL RS) resources, and a channel state information (CSI) reporting setting. The WTRU may be further configured to perform one or more measurements on one or more DL RSs. Performing the one or more measurements may comprise performing any of a DL RS received power (DL RSRP) measurement, and signal to interference and noise power ratio (SINR) on the one or more DL RSs. The WTRU may be further configured to determine a subset of DL RS resources based on the performed one or more measurements. The WTRU may be further configured to transmit a CSI report comprising first information indicating the determined subset of DL RS, wherein the CSI report is based on the CSI reporting setting. The CSI report may comprise second information indicating one or more results of the one or more measurements on the one or more DL RSs. The WTRU may be further configured to determine one or more spatial domain filters based on the determined subset of DL RS resources; and a configured to transmit a subset of one or more UL RS resources of the set of one or more UL RS using the determined one or more spatial domain filters.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a timing diagram illustrating an example of a time offset between an Uplink transmission and a CSI reporting on a physical uplink shared channel (PUSCH), according to an embodiment;

FIG. 3 is a timing diagram illustrating an example of a CSI reporting timing and an Uplink reference signal transmission timing according to an embodiment;

FIG. 4 is a timing diagram illustrating another example of a CSI reporting timing and an Uplink reference signal transmission timing according to another embodiment;

FIG. 5 is a block diagram illustrating an example of conceptual relations between reference signals according to an embodiment; and

FIG. 6 is a flow chart illustrating an example of a method, implemented in a WTRU, for selecting an uplink Tx Beam for transmission according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A sign, symbol, or mark of forward slash ‘/’ is to be interpreted as ‘and/or’ unless particularly mentioned otherwise, where for example, ‘A/B’ may imply ‘A and/or B’.

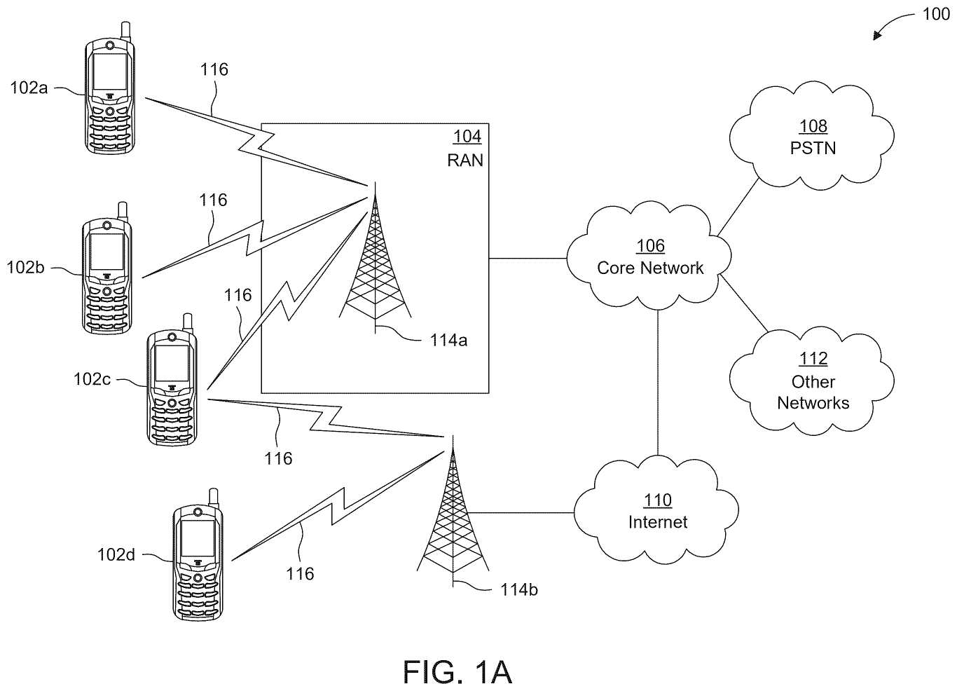

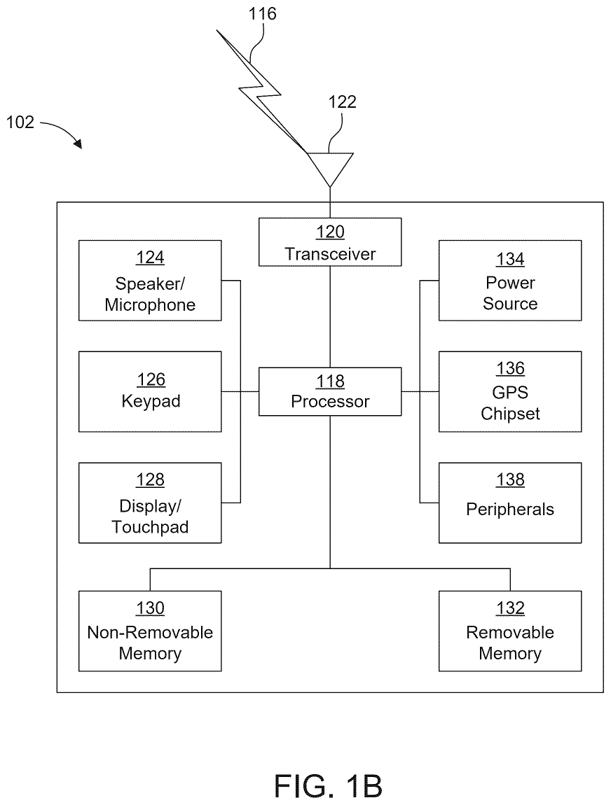

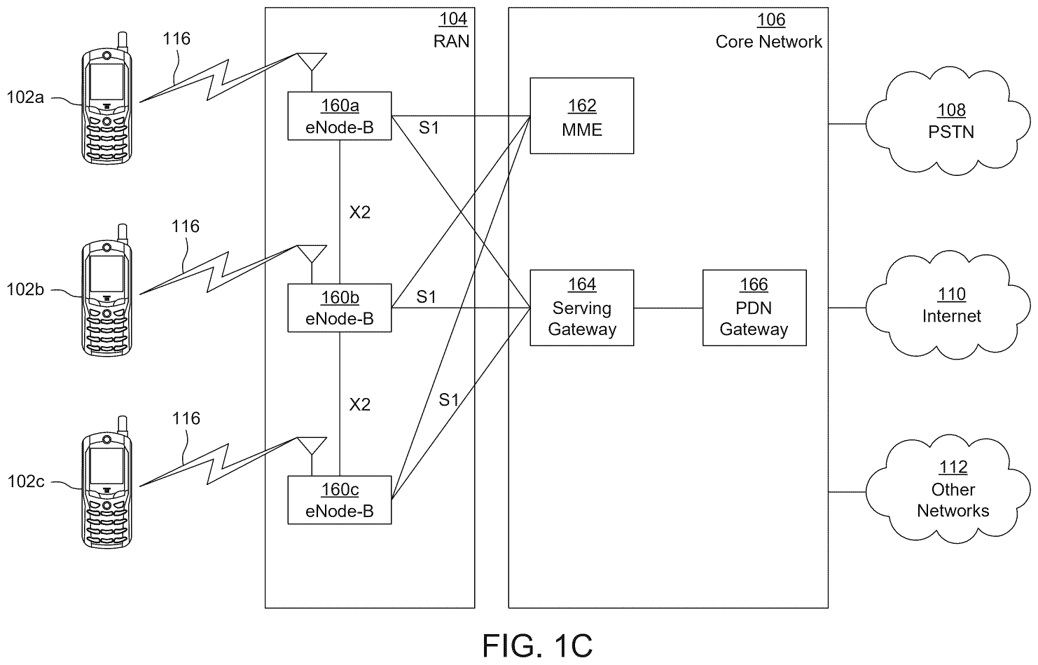

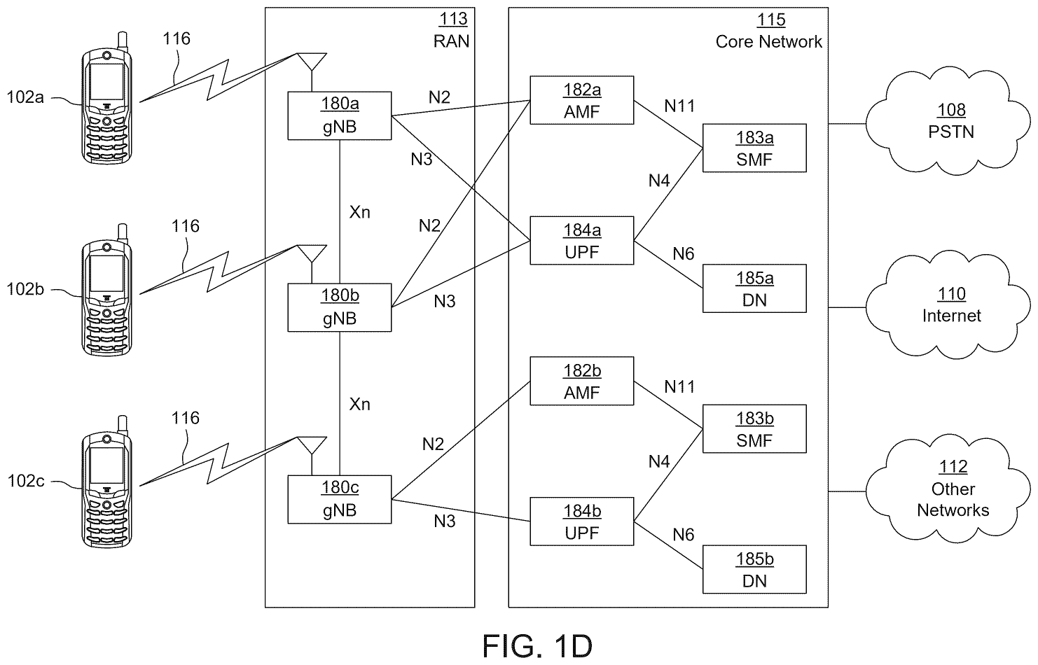

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The Node-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signalling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications, such as machine-type communications devices in a macro coverage area. Machine-type communications devices may have certain capabilities, for example, limited capabilities including support for (e.g., only support for) certain and/or limited bandwidths. The machine-type communications devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one access and mobility management function (AMF) 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signalling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The term channel state information reference signal (CSI-RS) may refer to one or more CSI-RS resource(s) or one or more antenna ports of a CSI-RS resource. It may also refer to a downlink (DL) RS, such as a synchronization signal (SS) and physical broadcast channel (PBCH) block (SS/PBCH block or SSB). Note that DL RS may for example refer to CSI-RS, SSB, physical DL control channel (PDCCH) demodulation RS (DMRS), physical downlink shared channel (PDSCH) DMRS, etc.

The term sounding reference signal (SRS) may for example refer to one or more SRS resource(s) or one or more antenna ports of one or more SRS resource(s). It may also refer to an uplink (UL) RS. UL RS may refer to SRS, physical uplink control channel (PUCCH) DMRS, physical uplink shared channel (PUSCH) DMRS, physical random access channel (PRACH), etc.

The term beam may refer to a spatial domain filter, e.g., a WTRU spatial domain filter. For instance, a DL receive (Rx) beam may refer to a spatial domain receive filter, while an UL transmit (Tx) beam may refer to a spatial domain transmit filter.

A beam may correspond to a precoder, e.g., a vector or matrix, that maps information or reference symbols to transmitter chains. A beam may correspond to a combiner or receiver filter, e.g., a vector or matrix, that maps signals, e.g., in a digital baseband domain, from receiver chains to information or reference symbols. A beam may correspond to a set of phase and/or amplitude shifts applied to a radio frequency (RF) signal prior to signal transmission from an antenna or after signal reception from an antenna. The term antenna may be broadly understood, for instance, as one or more antenna elements, an antenna array, a subarray of an antenna array, a panel, etc . . .

A beam corresponding to a DL RS, e.g., CSI-RS, may refer to a DL Rx beam a WTRU may use to receive the DL RS. A beam corresponding to an UL RS or UL channel may refer to an UL Tx beam a WTRU may use to transmit the UL RS/channel.

An UL Tx beam may correspond to a DL Rx beam, for instance for a WTRU that supports DL/UL beam correspondence. An UL Tx beam may have the same or similar main lobe angle-of-departure as the main lobe angle-of-arrival of the corresponding DL Rx beam.

The term spatial reference may refer to a DL RS or UL RS that a WTRU may use to determine a spatial domain transmit filter for a transmission of an UL signal/channel, such as SRS, PUCCH, PUSCH, etc. A spatial reference may be configured and/or indicated in a spatial relation and/or a transmission configuration indicator (TCI) state, such as a joint DL/UL TCI state or a separate UL TCI state.

The term antenna port used herein may correspond, for example, to any of the meanings of the term antenna port as used in state-of-the-art technologies or specifications. An antenna port may correspond to a logical or virtual antenna port that, e.g., may be transmitted from one or more antennas. An antenna port may also correspond to an actual or physical antenna port, e.g., comprising one or more physical antenna elements.

About WTRU configuration, a WTRU may receive one or more configuration(s) and/or reconfiguration(s), through radio resource control (RRC) signaling, in one or more RRC message(s).

About WTRU configuration of CSI-RS, the WTRU may receive a configuration of a configured set of one or more CSI-RS. The configured set of CSI-RS may correspond to a set of single-port CSI-RS resource(s), a set of dual-port CSI-RS resource(s), or a set of multi-port CSI-RS resource(s). The configured set of CSI-RS may correspond to CSI-RS resource(s) in one or more CSI-RS resource sets, e.g., non-zero-power CSI-RS resource sets. The configured set of CSI-RS may correspond to a set of antenna ports, e.g., of one or more CSI-RS resource(s).

The CSI-RS may be configured to be periodic. The WTRU may receive the CSI-RS with a configured periodicity and time offset to a time reference. A time reference may be, for instance, the start of a slot, subframe, or frame of a serving cell, e.g., the serving cell in which the CSI-RS are configured or received. In an example, a time reference may be the start of a slot with slot number ‘0’. A WTRU may determine the time reference based on one or more synchronization signals and/or broadcast channels, which for instance may be carried in one or more SSBs. A time reference may be the start of a signal or channel received by the WTRU, e.g., a synchronization signal, SSB, etc.

A time offset may be described in a time unit for example based on seconds, symbols, slots, subframes, frames, etc., or a combination thereof. In an example, a time offset may be a sum of a configured offset in slots and a configured offset in symbols. In another example, a time offset may be a configured offset in symbols.

The CSI-RS time domain behavior may depend on a numerology that may be configured, e.g., a sub-carrier spacing, symbol rate, etc. For instance, the CSI-RS periodicity, time offset, and/or time reference may depend on the numerology.

The CSI-RS may be configured to be semi-persistent. In case of the CSI-RS is activated, the WTRU may receive the CSI-RS with a configured periodicity and time offset to a time reference. The WTRU may receive a CSI-RS activation and/or deactivation indication for a semi-persistent CSI-RS in a medium access control (MAC) control element (CE) or in a downlink control information (DCI). A MAC CE may be carried in a PDSCH. A DCI may be carried in a PDCCH.

The CSI-RS may be configured to be aperiodic. The WTRU may receive one or more occasions of an aperiodic CSI-RS after the reception of a DCI that triggers the CSI-RS. The WTRU may receive the CSI-RS a time offset after receiving the PDCCH that carried the DCI that triggered the CSI-RS. In a non-limited example, a configured time offset, or a time offset may be indicated by the DCI, or a combination thereof.

A CSI-RS may be configured with or without repetition enabled.

For a CSI-RS with repetition enabled, the WTRU may receive multiple occasions of the CSI-RS, e.g., in consecutive symbols or slots. The WTRU may assume that the multiple occasions were transmitted on the same effective channel, e.g., with the same Tx beam. The WTRU may use the multiple occasions for adjusting its Rx beam.

For a CSI-RS with repetition disabled, the WTRU may receive multiple occasions of the CSI-RS, e.g., separated by the CSI-RS periodicity. The WTRU may use the multiple occasions for adjusting its Rx beam, even though the WTRU might not assume that the occasions were transmitted on the same effective channel, e.g., with the same Tx beam.

About WTRU configuration of CSI reporting, the WTRU may be configured with one or more CSI reporting settings. A CSI reporting setting may be configured with a CSI reporting setting identity/identifier (Id).

A CSI reporting setting may comprise a CSI reporting configuration comprising reporting quantity/quantities (also called metric(s)), number of reported CSI-RS, time domain properties such as periodic, semi-persistent, aperiodic, and corresponding periodicities, time offsets, etc., and other configurations described herein.

A CSI reporting setting may be linked to a CSI resource setting, which may correspond to a set of CSI-RS. The set of CSI-RS may be for channel measurement. A CSI resource setting may also comprise a set of resources, e.g., CSI-RS, for interference and/or noise measurement. The set of CSI-RS may correspond to the configured set of CSI-RS, or a subset thereof. Different CSI reporting settings may be linked to the same or different CSI resource settings, e.g., the same or different sets of CSI-RS.

The WTRU may be configured to report a reported subset of the configured set of CSI-RS. A subset may be, for example, reported using CSI-RS indices among the configured set of CSI-RS, e.g., CSI-RS resource index (CRI).

The WTRU may be configured to report a particular number of reported CSI-RS in the reported subset, e.g., a single CSI-RS, two CSI-RS, etc.

The WTRU may be configured to determine a number of reported CSI-RS in the reported subset. A maximum number of reported CSI-RS may be configured, e.g., explicitly or implicitly, or pre-defined. In a non-limited example, the maximum number may be given by a number of CSI-RS in the configured set of CSI-RS. In another example, the maximum number may be given by a CSI reporting format that may support reporting of up to a maximum number of CSI-RS. A minimum number of reported CSI-RS may be configured, e.g., explicitly, or implicitly, or pre-defined, e.g., 1. For brevity, the number of reported CSI-RS may be denoted herein as X.

A reporting quantity may be a RS received power (RSRP), signal to interference and noise power ratio (SINR), a channel quality indicator (CQI), a precoding matrix indicator (PMI), a rank indicator (RI), etc.

The WTRU may be configured to report a reporting quantity per reported CSI-RS, e.g., an RSRP and/or an SINR per reported CSI-RS. The WTRU may be configured to report a subset of the configured set of CSI-RS with highest or lowest reporting quantity, e.g., the CSI-RS with highest RSRP(s) or highest SINR(s).

The WTRU may be configured to report a reporting quantity, e.g., a CQI and/or a PMI, for a set of reported CSI-RS, e.g., for the reported subset of CSI-RS. The WTRU may be configured to report the subset of the configured set of CSI-RS with the CQI, PMI, and/or RI, etc., that corresponds to a highest or lowest metric, wherein the metric may be spectral efficiency, throughput, block error rate, etc.

The WTRU may be configured with one or more thresholds. The WTRU may be configured to use a threshold to determine the reported subset of CSI-RS and/or the number of reported CSI-RS, for instance by reporting CSI-RS with a quantity above or below a threshold.

The WTRU may be configured to transmit a CSI report periodically, e.g., on a PUCCH. The WTRU may be configured with multiple CSI reporting settings with periodic reporting that may correspond to the same or different reporting quantities, RS(s), periodicities, PUCCH resources, etc.

The WTRU may be configured to transmit a CSI report semi-persistently, e.g., on a PUCCH or PUSCH, with a configured periodicity and/or time offset, when reporting is activated.

The WTRU may be configured with multiple CSI reporting settings with semi-persistent reporting on PUCCH and/or PUSCH that may correspond to the same or different reporting quantities, RS(s), periodicities, PUCCH resources, etc.

The WTRU may be configured to transmit a CSI report aperiodically on PUSCH in case of reporting is triggered. The WTRU may be configured with one or more CSI trigger states that each may correspond to one or more CSI reporting setting(s).

About WTRU configuration of SRS, the WTRU may receive a configuration of a configured set of one or more SRS. The configured set of SRS may correspond to a set of single-port SRS resource(s), a set of dual-port SRS resource(s), or a set of multi-port SRS resource(s). The configured set of SRS may correspond to SRS resource(s) in one or more SRS resource sets.

One or more SRS may be associated with an SRS identifier (Id). For example, an SRS resource may be configured with an SRS resource Id. In another example, an SRS resource set may be configured with an SRS resource set Id. The configured set of SRS may correspond to a set of antenna ports, e.g., of one or more SRS resource(s).

The configured set of SRS may be configured via one or more SRS resource configurations, e.g., for aperiodic SRS, comprising one or more (time) offset configurations. In details, each SRS resource configuration may indicate at least one SRS resource to be used by the WTRU for SRS transmission and may also indicate a spatial reference; an SRS resource configuration, or SRS resource set configuration, may be associated with an offset configuration; and each offset configuration may indicate at least an offset value to be applied by the WTRU to determine an SRS transmission timing.

The unit of offset value may be configured in several alternative ways such as radio frame, subframe, slot, subslot, or symbol. For example, in case of the offset value is interpreted as slot, the offset value may indicate a number of slots the WTRU should apply for the SRS resource determination.

A WTRU may also be configured (e.g., for an SRS resource set) with a set of (e.g., time) offset values from which an offset value may be selected via a DCI that the WTRU receives, e.g., the SRS-triggering DCI.

An SRS resource set configuration may also comprise a configuration of power control. An SRS resource set configuration may also comprise a configuration of the usage of the SRS resource set, e.g., for usages beam management, codebook based UL transmission schemes, non-codebook UL transmission schemes, antenna switching, etc.

The WTRU may receive a configuration that associates one or more SRS with one or more CSI-RS. The WTRU may be configured to determine spatial reference(s) for the SRS based on a CSI report comprising a subset of the one or more CSI-RS.

In one example, one or more SRS resource(s) may be associated with one or more CSI-RS resource(s), e.g., in one or more CSI-RS resource set(s). In another example, an SRS resource set may be associated with one or more CSI-RS resource(s). The one or more CSI-RS may comprise the one or more antenna ports of the associated CSI-RS resource(s). In yet another example, an SRS resource may be associated with a CSI-RS resource set.

The association may be configured in an SRS resource configuration or SRS resource set configuration by including one or more CSI-RS Id(s) in the configuration, e.g., CSI-RS resource Id(s) or CSI-RS resource set Id(s). The association may be configured in a CSI-RS resource configuration or CSI-RS resource set configuration by including one or more SRS Id(s) in the configuration, e.g., SRS resource Id(s) or SRS resource set Id(s).

The WTRU may receive a configuration that associates one or more SRS with one or more CSI reporting settings. The association may imply that the WTRU may update the spatial reference(s) of the one or more SRS based on one or more CSI report(s) corresponding to the associated CSI reporting setting. The association configuration may comprise one or more CSI report setting Ids in the configuration of the one or more SRS, for instance in an SRS resource set configuration or an SRS resource configuration. The association configuration may comprise one or more SRS Ids in the configuration of a CSI reporting setting. For instance, a CSI reporting setting may be configured with one or more SRS resource set Id.

About WTRU configuration of spatial relations and/or TCI states, the WTRU may receive a configuration of a set of spatial relations and/or TCI states. A spatial relation and/or TCI state may comprise an RS that the WTRU may use as a spatial reference for an UL transmission. A spatial reference may comprise a spatial relation and/or a TCI state, such as a joint DL/UL TCI state or an UL TCI state. Using a DL RS as a spatial reference for an UL signal/channel may mean that the WTRU may use the (e.g., DL Rx) beam used to receive the DL RS as the (e.g., UL Tx) beam to transmit the UL signal/channel. Similarly, using an UL RS as a spatial reference for an UL signal/channel may mean that the WTRU may use the (e.g., UL Tx) beam used to transmit the UL RS as the (e.g., UL Tx) beam to transmit the UL signal/channel.

A TCI state may comprise one or more source RS(s) that the WTRU may use as quasi-co-location (QCL) source RS(s) for receiving a DL signal/channel. The TCI state may also comprise a configuration of one or more QCL types applicable to the one or more source RS(s), wherein the QCL type may comprise one or more of Doppler shift, Doppler spread, average delay, delay spread, and spatial Rx parameter.

A set of one or more SRS may be configured with one or more spatial reference(s). In an example, an SRS resource in an SRS resource set may be configured with one or more spatial reference(s).

A CSI-RS may be associated with a spatial relation or a TCI state if the spatial relation or TCI state comprises the CSI-RS. In another example, a CSI-RS may be associated with a spatial relation or a TCI state by a configured association, e.g., such that an Id of a spatial relation or TCI state may be configured for a CSI-RS.

About WTRU configuration of PUSCH grant, the WTRU may receive a configuration of a PUSCH grant, e.g., a periodic or semi-persistent grant.

About WTRU determination of reported subset of CSI-RS, the WTRU may receive one or more CSI-RS from the set of configured CSI-RS, e.g., all CSI-RS in the set of configured CSI-RS. The received CSI-RS may correspond to the CSI-RS linked with one or more configured CSI reporting settings.

The WTRU may receive one or more occasions of one or more configured periodic CSI-RS. The WTRU may receive one or more occasions of one or more configured and activated semi-persistent CSI-RS. The WTRU may receive one or more occasions of a configured and triggered aperiodic CSI-RS. If configured, a CSI-RS occasion may comprise CSI-RS repetition.

The WTRU may use one or more DL Rx beam(s) for receiving the one or more CSI-RS occasions, whereby the WTRU may determine a DL Rx beam for the CSI-RS. The WTRU may apply the determined beam if the CSI-RS is used as a spatial reference for an UL transmission.

Further to the reception of the CSI-RS and further to the WTRU Rx beam adjustment(s), The WTRU may determine a reported subset of CSI-RS. The reported subset of CSI-RS may correspond to a configured CSI reporting setting. The determination may be based on the received CSI-RS, e.g., based on the WTRU performing a measurement on the received CSI-RS. The determination may be based on the WTRU evaluating one or more quantities, e.g., based on the configured reporting quantities. In some cases, the WTRU may report the reported subset of CSI-RS but not the corresponding quantities. The WTRU may determine a quantity per CSI-RS. In this case, the WTRU may determine the reported subset of CSI-RS based on the one or more CSI-RS with highest or lowest determined quantities.

Alternatively, the WTRU may determine a quantity per subset of CSI-RS. In this case, the WTRU may determine the reported subset of CSI-RS based on the subset that corresponds to the highest or lowest determined quantity.

The WTRU may also determine the size of the reported subset of CSI-RS, X, i.e., the number of reported CSI-RS, (e.g., if configured to do so). For example, the WTRU may determine the number of reported CSI-RS as the number of CSI-RS with a quantity above or below a threshold, which may be configurable. In another example, the WTRU may determine the number of reported CSI-RS as the number of CSI-RS that maximizes or minimizes a reported quantity.

The WTRU may determine an RSRP per received CSI-RS. In this case, the WTRU may determine the reported subset of CSI-RS as the set of CSI-RS with highest RSRP. In case of the number of reported CSI-RS X is given, e.g., by being pre-defined or configured to the WTRU, the WTRU may determine the X CSI-RS with the highest RSRP. In case of the WTRU is to determine the number of reported CSI-RS, X, the WTRU may determine X as the number of CSI-RS with corresponding RSRP above a threshold.

The determination of the subset of CSI-RS with the highest SINR may be similar to the RSRP-based determination, but with SINR used as quantity. The interference and/or noise measurement corresponding to the SINR of a CSI-RS may be based on a measurement on the CSI-RS itself, or on one or more measurement(s) on other resources that may configured as interference resource(s) for the CSI-RS. In some cases, the WTRU may also determine and report information regarding the interference of an SINR corresponding to a CSI-RS, e.g., one or more other CSI-RS that were used to determine the interference in the SINR calculation.

The WTRU may determine a throughput, CQI, spectral efficiency (SE), or the like, for one or more subsets of CSI-RS. The throughput may correspond to a hypothetical throughput, e.g., for a hypothetical PDSCH. The WTRU may determine a reported subset of CSI-RS as a subset of CSI-RS with highest throughput.

In some cases, the determination of reported CSI-RS may comprise a determination of a subset of antenna ports of one or more multi-port CSI-RS resource(s). The reported subset of CSI-RS may comprise a subset of CSI-RS antenna ports. The reported subset may be carried in a PMI.

The WTRU may take additional constraints into account when determining the reported subset of CSI-RS. As a non-limited example, there may be constraints on which beams the WTRU can transmit simultaneously. Since a goal may be to eventually support single-or multi-layer PUSCH, the CSI reporting may also take the simultaneous UL transmission condition into account.

In one example, the WTRU may determine the reported subset of CSI-RS such that the set of DL Rx beams corresponding to the subset of CSI-RS may correspond to a set of UL Tx beams that can be transmitted simultaneously. In another example, the WTRU may determine the reported subset of CSI-RS such that the CSI-RS in the subset correspond to different DL Rx beams.

In an alternative, the WTRU may determine the reported subset of CSI-RS without constraints on simultaneous UL transmission and/or different DL Rx beams, as described above. The CSI report may comprise an additional indication of which CSI-RS in the reported subset that correspond to different UL Tx beams that can be transmitted simultaneously and/or an additional indication of which CSI-RS in the reported subset that correspond to the same or different DL Rx beams. Simultaneous transmission of multiple signals/channels with different UL Tx beams may correspond, for instance, to one or more of transmission in the same symbol and/or slot, transmission in time instances separated in time by less than a threshold, etc.

About WTRU CSI reporting, the WTRU may report the determined reported subset of CSI-RS, e.g., based on a corresponding CSI reporting setting. The report of the subset may comprise resource indices, such as CRI(s), SSBRI(s), or similar suitable indices. In addition to the reported subset of CSI-RS, the CSI report may comprise the reporting quantities corresponding to the reported subset. For example, the CSI report may include one or more RSRP value(s) and/or SINR value(s) for the one or more CSI-RS in the reported subset. In another example, the CSI report may include one or more of CQI, RI, PMI. In some cases, the reported subset of CSI-RS may be reported using one or more PMI(s). For instance, a PMI may comprise an indication of a sub-set of CSI-RS antenna ports, which may correspond to the reported subset of CSI-RS.

In some cases, the CSI report may comprise the reported subset of CSI-RS without the corresponding one or more quantities. In an example, e.g., in case of SRS for DL CSI acquisition (e.g., SRS with antenna switching), in case of the number of simultaneously usable TX and RX chains is different, the WTRU may indicate to the network how the reported CSI-RS(s) are associated with the transmit antenna groups, e.g., which reported CSI-RS(s) correspond to the same transmit antenna group. As a non-limited example, the WTRU may include in the reported subset of CSI-RS, the CSI-RSs for the first transmit antenna group followed by the CSI-RSs for the second transmit antenna group.

In another example, e.g., in case of SRS for DL CSI acquisition (e.g., SRS with antenna switching), when the number of aggregated carriers in DL and UL is different, the WTRU may indicate to the network how the reported CSI-RSs are associated with the different carriers, e.g., which reported CSI-RSs corresponding to the same carrier. For instance, the WTRU may include in the reported subset of CSI-RS, the CSI-RSs for the first carrier (e.g., primary carrier) followed by the CSI-RSs for the second carrier (e.g., PUSCH-less carrier).

The WTRU may transmit a CSI report on one or more CSI reporting resource(s), wherein a resource may comprise one or more of a time resource, a frequency resource, a code resource, a spatial resource, etc. CSI reporting resource(s) may comprise one or more CSI reporting PUCCH resource(s). CSI reporting resource(s) may comprise one or more CSI reporting PUSCH resource(s).

The WTRU may determine and report the reported subset of CSI-RS periodically, e.g., by periodically transmitting the CSI report on one or more CSI reporting resource(s), such as one or more CSI reporting PUCCH resource(s).

The WTRU may determine and report the reported subset of CSI-RS semi-persistently, e.g., with a configured periodicity when the reporting is activated. The reporting may be activated upon WTRU reception of a CSI-activating MAC CE or a CSI-activating DCI. The WTRU may stop the reporting upon WTRU reception of a CSI-deactivating MAC CE/DCI, or alternatively after a number of CSI reports have been transmitted after the activation. A CSI report may be transmitted on one or more CSI reporting resource(s), e.g., one or more CSI reporting PUCCH resource(s) or one or more CSI reporting PUSCH resource(s).

The CSI-activating MAC CE/DCI may also indicate the enhanced functionality described herein, e.g., that the WTRU may determine spatial reference(s), e.g., for SRS and/or PUSCH, based on the reported subset of CSI-RS.

The CSI-activating MAC CE/DCI may indicate a set of SRS for which spatial reference(s) may be updated, e.g., an SRS resource set. The CSI-activating MAC CE/DCI may also activate SRS transmission, e.g., activate semi-persistent SRS. In other words, the CSI-activating MAC CE/DCI may also be an SRS-activating MAC CE/DCI, wherein an SRS-activating MAC CE or SRS-activating DCI may activate transmission of semi-persistent SRS.

Alternatively, the WTRU may expect to receive a separate CSI-activating MAC CE and an SRS-activating MAC CE in the same PDSCH. The CSI-activating MAC CE and/or SRS-activating MAC CE may indicate that the WTRU may determine spatial relation(s) for the corresponding SRS based on the corresponding activated CSI reports.

A CSI-activating DCI may also trigger the transmission of one or more aperiodic SRS, e.g., the CSI-RS activating DCI may also be an SRS-triggering DCI.

Each transmission of a periodic/semi-persistent CSI report corresponding to a CSI reporting setting may comprise a reported subset of CSI-RS, etc., wherein different transmitted CSI reports may comprise different reported subsets of CSI-RS, etc.

The WTRU may determine and report the reported subset of CSI-RS aperiodically, e.g., upon the reception of a CSI-triggering DCI.

The CSI-triggering DCI may indicate one or more CSI reporting resource(s) for the transmission of the CSI report. For example, the WTRU may indicate time resources and/or frequency resources for one or more PUSCH transmission occasions that the WTRU may use to transmit the CSI report. A time resource may comprise one or more slots and/or one or more symbols in the slot(s), for example OFDM symbols, for a numerology.

The CSI-triggering DCI may also indicate the enhanced functionality described herein, e.g., that the WTRU may determine spatial reference(s), e.g., for SRS and/or PUSCH, based on the reported subset of CSI-RS.

A CSI-triggering DCI may also be an SRS-triggering DCI, e.g., trigger the transmission of one or more aperiodic SRS. The triggered SRS may correspond to the one or more SRS for which spatial reference(s) may be updated based on the subset of CSI-RS reported in the triggered CSI report.

One or more spatial reference(s) may be used for a PUSCH transmission occasion, and the same or different spatial reference(s) may be used in different PUSCH transmission occasions, e.g., in multiple occasions used to transmit a CSI report.

As described above, the WTRU may transmit a CSI report on one or more PUSCH occasions. Normally, the spatial reference(s) used for the PUSCH transmission(s) may be based on the spatial reference(s) used for the SRS that were indicated in the DCI that scheduled or activated the PUSCH or that were configured for the PUSCH, e.g., in the form of one or more SRI(s).

In an alternative, the WTRU may determine the spatial reference(s) for the PUSCH transmission(s) based on the reported set of CSI-RS that is to be reported in the PUSCH.

For example, the WTRU may be configured to determine the spatial reference(s) for the PUSCH transmission(s) based on the reported set of CSI-RS, e.g., as a subset of the reported subset of CSI-RS. The number of spatial reference(s) for the PUSCH may be indicated or configured to the WTRU or determined by the WTRU. The WTRU may determine the subset of the reported subset of CSI-RS based on any of the methods described herein, such as based on the reported quantities, etc.

In an example, the DCI that scheduled or activated the PUSCH may include a field that indicates a subset of the reported subset of CSI-RS, e.g., one or more CRI fields, or a field that indicates a CSI-RS among the CSI-RS in the reported subset of CSI-RS, such as the first N CSI-RS in the report or the N CSI-RS in the report with highest measurement value(s), etc., where N may be 1, 2, . . . , etc.

The DCI may carry an indication of whether the WTRU shall transmit the PUSCH according to legacy methods, e.g., based on configured/activated/indicated SRI(s), or whether the WTRU shall transmit the PUSCH using spatial reference(s) based on CSI-RS reported in the PUSCH.

As described above, the WTRU may transmit a CSI report on one or more PUCCH occasions. Similarly to the CSI reporting on PUSCH, the WTRU may determine spatial reference(s) for the PUCCH occasion(s) based on the reported set of CSI-RS. The WTRU may be configured with the number of spatial reference(s) for a PUCCH resource.

About WTRU determination of spatial reference(s) for SRS, the WTRU may receive an indication of an indicated subset of CSI-RS, which may be a subset of the reported set of CSI-RS. The WTRU may determine an update subset of CSI-RS, e.g., based on the reported set of CSI-RS and/or the indicated subset of CSI-RS. The WTRU may receive an indication of an indicated subset of SRS, which may be a subset of the configured set of SRS. The WTRU may determine an update subset of SRS, e.g., based on the configured set of SRS, the indicated subset of SRS, etc. The WTRU may base the spatial reference(s) for the update subset of SRS on the update subset of CSI-RS, e.g., the CSI-RS may be used as spatial reference(s). The WTRU may determine a transmission subset of the configured set of SRS that is to be transmitted, which may be a subset of the configured set of SRS, a subset of the indicated subset of SRS, and/or a subset of the update subset of SRS.

In various embodiments, a WTRU may determine one or more spatial reference(s) for SRS based on a just reported subset of CSI-RS. Typically, the reported CSI-RS may represent a set of (e.g., good, preferred) transmission modes at the network side, for instance one or more of TRP sub-array(s), TRP(s), beam(s), etc. The set of (e.g., good, preferred) transmission modes may also represent a set of (e.g., good, preferred) reception modes, such as TRP sub-array(s), TRP(s), beam(s), etc., e.g., if the network implements DL/UL reciprocity and/or beam correspondence. Hence, the schemes herein may allow for a very fast adaptation of WTRU-side spatial references and/or network-side UL reception modes. If the updated SRS is transmitted after the corresponding CSI report, the network may have time to receive and decode the CSI report and adjust its reception modes in time for the reception of the SRS transmitted by the WTRU.

The WTRU may be configured to determine an update subset of CSI-RS and/or update subset of SRS without receiving indication(s) of indicated subsets. The WTRU may determine an update subset of CSI-RS and/or update subset of SRS directly based on the reported set of CSI-RS and/or the configured set of SRS.

The WTRU may update the spatial reference(s) of the SRS based on the latest transmitted applicable CSI report, which may be periodic, semi-persistent, or aperiodic. The latest transmitted applicable CSI report may correspond to a CSI reporting setting, or a set of CSI-RS associated with the SRS. A CSI report may be applicable if it was transmitted at least a certain time before the SRS transmission time, wherein the SRS transmission time may correspond to a slot in which the SRS is/are to be transmitted. The SRS transmission time may correspond to an earliest transmission time among the SRS, e.g., the transmission subset of SRS, or the update subset of SRS.

In case of semi-persistent CSI reporting and/or semi-persistent SRS, the CSI reporting and/or SRS may be separately activated, e.g., in separate DCIs or MAC CEs, or jointly activated, e.g., in the same DCI, the same MAC CE, or with separate MAC CEs carried by the same PDSCH. The CSI-activating MAC CE/DCI and/or the SRS-activating MAC CE/DCI may indicate that the WTRU may update the spatial reference(s) of the (e.g., activated) SRS based on the reported set of CSI-RS, e.g., in the activated CSI. Furthermore, the association between the CSI reporting and the SRS may be indicated in the CSI- and/or SRS-activating MAC CE/DCI. In case of joint activation, the association may be implicitly indicated by the joint activation in the same MAC CE or DCI.

The WTRU may perform CSI reporting before updating SRS spatial reference(s) without network confirmation. The WTRU may directly update the spatial reference(s) for the configured SRS resources after a CSI reporting which includes the subset of CSI-RS (e.g., reported using CRI(s)). Note: an SRS resource in an SRS resource set can be configured with spatial reference in the reported subset of CSI-RS. The Y SRS resource(s) (e.g., identified by SRS resource indicator(s) (SRI(s))) may have one-to-one spatial relations with the reported/selected Y CRI(s), e.g., subset of the set of configured CSI-RS. The network may obtain the SRS spatial references based on reported subset of CSI-RS in a CSI report from the WTRU. For example, the reported CRI(s) in the reported subset of CSI-RS is ordered from low to high index and the spatial references may correspondent to the CRI from low to high index of SRS.

The WTRU may directly update SRS spatial relationships without CSI reporting. The WTRU may perform measurement (e.g., RSRP/L1-SINR) and may select best X CSI-RS from the set of (configured) CSI-RS. The WTRU may directly update spatial reference(s) of configured SRS resources without CSI reporting. In addition, each SRS resource in a (configured) SRS resource set may be configured with one of the spatial references which is in the reported/selected subset of CSI-RS. The spatial relationship with the selected X CRI, i.e., can be indicated in the configured (set of) SRS. The X selected subset of CSI-RS/CRI and its corresponding spatial reference(s) can be implicitly indicated in each SRS resource (e.g. in an SRS resource set). The network may perform the detection via using the spatial information from the configured CRI. Therefore, the X SRS resource (SRI) has one-to-one spatial relations with the reported/selected subset of X CSI-RS/CRI. The selected subset of CSI-RS with its spatial relationship can be explicitly indicated in each SRS resource. For example, a CRI can be indicated by the WTRU by the mapping of a SRS sequence to a configured SRS resource. In other words, CRI and SRS sequence can be pre-configured or configured for an SRS resource and the WTRU may select an SRS sequence for SRS transmission on an SRS resource, e.g., based on the CRI used as spatial reference for the SRS transmission. As a non-limited example, the CRI and SRS sequence mapping rule can be based on selecting from a base sequence with different group and different cyclic shift, i.e., the SRS sequence can be based on selecting function like {u,c}=f(CRI), where u is the group ID for a base sequence and c is the cyclic shift number.

The WTRU may receive an indication that confirms that the WTRU may update spatial reference(s) for SRS in the update subset of SRS, e.g., based on a reported subset of CSI-RS. It may be carried in a DCI, e.g., an SRS-triggering DCI or SRS-activating DCI, or in a MAC CE, e.g., an SRS-activating MAC CE. The indication may be received after the transmission of the corresponding CSI report, e.g., within a time window (e.g., configurable time window) after the transmission of the CSI report. The indication may comprise a field, e.g., a bit, in a DCI or MAC CE corresponding to spatial reference update. In case of the WTRU receives a DCI or MAC CE with a bit set, the WTRU may update the spatial reference(s). Otherwise, the WTRU may not update the spatial reference(s).

The WTRU may receive an SRS-triggering DCI, that may be different from the CSI-triggering DCI, or CSI-activating DCI. The reception of an SRS-triggering DCI after a CSI reporting resource may implicitly confirm the update of spatial reference(s) based on the reported subset of CSI-RS. The implicit confirmation may be based on the reception of the SRS-triggering DCI, at least a first time offset after a CSI reporting resource, e.g., the latest CSI reporting resource carrying a CSI report in case of CSI report transmission on multiple CSI reporting resources. The CSI report may correspond to a CSI reporting setting associated with the triggered SRS. Similarly, the implicit confirmation may be based on the reception of the SRS-triggering DCI, no more than a second time offset after a CSI reporting resource. The first and second time offset may be predefined or configured. Similarly, an implicit confirmation may be based on the reception of an SRS-activating DCI within a time window after a CSI reporting resource corresponding to a CSI reporting setting associated with the activated SRS.

In some cases, the WTRU may determine spatial reference(s) for one or more PUSCH based on similar methods as described herein for SRS. One or more spatial reference(s) may apply to a PUSCH transmission layer and/or a PUSCH transmission occasion, with potentially different spatial reference(s) applied to different layers/occasions. A WTRU may apply spatial reference(s) for one or more PUSCH (layers/occasions) based on the reported subset of CSI-RS, e.g., in case of a DCI that activates a semi-persistent PUSCH is received within a time window after a CSI reporting resource.

The WTRU may receive an indication of an indicated subset of CSI-RS, e.g., in an SRS-triggering DCI or in an SRS-activating MAC CE. By indicating a subset of the reported CSI-RS rather than a subset of the configured or measured CSI-RS, overhead can be reduced. Also, the WTRU effort may be reduced since the WTRU may focus on tracking the beams for the reported CSI-RS.

In various embodiments, a network may predict a WTRU for the determination of WTRU's UL spatial relationship. In this mode/case (i.e., UL spatial prediction), the WTRU may not need to perform CSI measurement in DL and the WRU may use the network indication of subset of CSI for SRS spatial reference. The WTRU may receive the updated spatial relationship on the configured SRS resources without CSI measurement and reporting. The WTRU may receive the updated SRS spatial reference can be based on periodic, semi-persistent, or aperiodic. The WTRU may be configured with the updated periodicity, e.g., 80 ms, 160 ms, etc., in case of the updated spatial reference is enabled for periodic or semi-persistent.

The WTRU may receive an indication of an indicated subset of CSI-RS in a DCI, e.g., an SRS-triggering DCI, a DCI that activates a (semi-persistent) PUSCH grant, a DCI that activates a semi-persistent SRS, etc. The WTRU may receive an indication of an indicated subset of CSI-RS in a MAC CE, e.g., a MAC CE based indication to activate a PUSCH grant, a MAC CE based indication to activate semi-persistent SRS. The indication may be in the form of a bitmap, e.g., with length equal to or greater than the number of reported CSI-RS. The bits may correspond to the CSI-RS in the reported subset of CSI-RS. A value, e.g., ‘1’, may correspond to that the corresponding CSI-RS is included in the indicated subset of CSI-RS.

Alternatively, the indication may be in the form of the number of CSI-RS to include in the indicated subset of CSI-RS. The WTRU may determine which CSI-RS to include from the reported subset of CSI-RS, e.g., based on the corresponding reported quantities such as the CSI-RS with highest reported RSRP. Alternative methods to determine which CSI-RS to include may follow principles proposed for the determination of the reported subset of CSI-RS. For example, the WTRU may determine CSI-RS for the indicated subset of CSI-RS such that the included CSI-RS correspond to different UL Tx beam that the WTRU may transmit simultaneously, etc.

In another alternative, the indication may be in the form of one or more CSI-RS indices, for example, indices among the reported subset of CSI-RS. For instance, if the reported subset of CSI-RS comprises two CSI-RS, the indication may comprise a 1-bit CSI-RS index, indicating one of the two reported CSI-RS. For instance, if the reported subset of CSI-RS comprises three or four CSI-RS, the indication may comprise one or more 2-bit CSI-RS indices, each index indicating one of the three or four reported CSI-RS. Such an indication may require less bits than a CSI-RS index among the larger set of configured CSI-RS, for instance.

In various embodiments, the number of indicated CSI-RS may be limited to a maximum number, for instance the number of SRS in the configured set of SRS. The maximum number of indicated CSI-RS may be equal to the number of reported CSI-RS.

The WTRU may have reported multiple CSI reports, e.g., corresponding to different CSI reporting settings. The indication of an indicated subset of CSI-RS may comprise an indication of one of the multiple CSI reports. The indication may comprise an indication of a CSI reporting setting. The indicated subset of CSI-RS may comprise the set of CSI-RS used for channel measurement in the indicated CSI reporting setting. The indication may comprise a direct indication of a set of CSI-RS, e.g., a multi-port CSI-RS or a CSI resource set. The indication may comprise a field, e.g., a bit, in a DCI or MAC CE corresponding to spatial reference update. Iin case of the WTRU receives a DCI or MAC CE with the field set to a value, the WTRU may update the spatial reference(s), as described herein. Otherwise, the WTRU may maintain the existing spatial reference(s) for SRS or use legacy spatial reference updating.

The update of spatial reference(s) may take effect in case of the WTRU receive an ACK, e.g., a network confirmation of spatial reference update, as described above. For semi-persistent CSI and/or SRS, a bit in a DCI may indicate the enabling or disabling of the spatial reference that was determined based on a CSI report, as described herein.

The WTRU may determine the update subset of CSI-RS based on a reported subset of CSI-RS, e.g., in case of the WTRU hasn't received an applicable indicated subset of CSI-RS. The update subset may be equal to the reported subset of CSI-RS, in which case the terms may be interchangeable herein. The WTRU may determine the update subset of CSI-RS based on an indicated subset of CSI-RS. The update subset may be equal to the indicated subset of CSI-RS, in which case the terms may be interchangeable herein. The WTRU may determine the update subset of CSI-RS upon network confirmation of SRS spatial reference update. The WTRU may determine the update subset of CSI-RS without network confirmation.

The number of reported and/or indicated CSI-RS may be greater than the number of SRS in the update subset of SRS. If so, the WTRU may determine the update subset of CSI-RS as a subset of the reported set of CSI and/or indicated subset of CSI-RS, e.g., with as many elements as the number of SRS in the update subset of SRS.

The WTRU may determine the update subset of CSI-RS from the reported set or indicated subset of CSI-RS based on similar principles as was described for determining the reported set of CSI-RS, e.g., based on the highest reported quantities, such that the determined CSI-RS correspond to different UL Tx beams, etc. Alternatively, the WTRU may select CSI-RS based on a CSI-RS index, such as CSI-RS resource Id, or CSI-RS antenna port Id. In another alternative, the WTRU may select the CSI-RS based on the most recently received CSI-RS or the CSI-RS in the most recently transmitted CSI report (in case the reported/indicated CSI-RS correspond to multiple CSI reports).

The WTRU may receive an indication of an indicated subset of SRS in a DCI, e.g., an SRS-triggering DCI, a DCI that activates a (semi-persistent) PUSCH grant, a DCI that activates a semi-persistent SRS, etc. The WTRU may receive an indication of an indicated subset of SRS in a MAC CE, e.g., a MAC CE based indication to activate a PUSCH grant, a MAC CE based indication to activate semi-persistent SRS. The indication may be in the form of a bitmap, e.g., with length equal to the number of SRS in the set of configured SRS. The bits may correspond to the SRS in the set of configured of SRS. A value, e.g., ‘1’, may correspond to that the corresponding SRS is included in the indicated subset of SRS. Alternatively, the indication may be in the form of the number of SRS to include in the update subset of SRS. The UE may determine which SRS to include from the set of configured SRS, e.g., based on various SRS selection methods described herein, such as for the determination of the transmission subset of SRS. In another alternative, the indication may be in the form of one or more SRS indices, for example, indices among the set of configured SRS. The one or more SRS indices may comprise one or more SRS resource set indices.

In various embodiments, the number of indicated SRS may be limited to a maximum number, for instance the number of SRS in the configured set of SRS. In other cases, the maximum number of indicated SRS may be equal to the number of reported CSI-RS.

The WTRU may determine the update subset of SRS based on a configured set of SRS, e.g., in case of the WTRU hasn't received an applicable indicated subset of SRS. The update subset may be equal to the configured set of SRS, in which case the terms may be interchangeable herein. The WTRU may determine the update subset of SRS based on an indicated subset of SRS. The update subset may be equal to the indicated subset of SRS, in which case the terms may be interchangeable herein. The WTRU may determine the update subset of SRS upon network confirmation of SRS spatial reference update. The WTRU may determine the update subset of SRS without network confirmation.

The number of configured and/or indicated SRS may be greater than the number of CSI-RS in the update subset of CSI-RS. If so, the WTRU may determine the update subset of SRS as a subset of the configured set of SRS and/or indicated subset of SRS, e.g., with as many elements as the number of CSI-RS in the update subset of CSI-RS.

The WTRU may determine the size of the update subset of SRS such that each SRS in the update subset of SRS correspond to different UL Tx beams, e.g., by excluding SRS(s) with the same UL Tx beam as another SRS in the subset.

The WTRU may determine the update subset of SRS from the configured set or indicated subset of SRS based on similar principles as described below for determining a transmission subset of SRS, e.g., based on priorities, SRS Ids, etc.

The number of CSI-RS in the update subset may be the same as the number of SRS in the update subset of SRS. The WTRU may determine a mapping, e.g., a 1-to-1 mapping, between the CSI-RS in the update subset of CSI-RS and the SRS in the update subset of SRS. The mapping may be achieved by ordering the CSI-RS in the update subset of CSI-RS and ordering the SRS in the update subset of SRS, and then mapping the 1st CSI-RS to the 1st SRS, etc. The ordering of the CSI-RS may follow any of the examples given herein, such as based on a CSI-RS index/Id, corresponding reported metric, timing, etc., or other applicable ordering method. Similarly, the ordering of the SRS may follow any of the examples given herein, such as SRS priority, Id, timing, etc., or other applicable ordering method.

A CSI-RS to SRS mapping may correspond to the spatial reference(s) of the one or more SRS being updated to the mapped one or more CSI-RS. In a non-limited example, in which different CSI-RS may be associated with different spatial relations or TCI states, a CSI-RS to SRS mapping may correspond to the spatial reference of the SRS being updated to the spatial relation(s) or TCI state(s) associated with the mapped CSI-RS.

In various embodiments, the number of CSI-RS in the update subset may be greater than the number of SRS in the update subset of SRS, for example, if one or more SRS have been configured/indicated to have multiple spatial references. In this case, the WTRU may determine multiple update subsets of CSI-RS and multiple update subsets of SRS, with a pair of CSI-RS/SRS subsets corresponding to a number of spatial references per SRS. The WTRU may perform the mapping operation per subset pair. Alternatively, the WTRU may determine the update subset of CSI-RS to comprise elements of one or multiple CSI-RS, wherein the elements with one CSI-RS may be mapped to SRS with a single spatial reference, the elements with two CSI-RS may be mapped to SRS with two spatial references, etc.

The WTRU may update the spatial reference(s) for the SRS in the update subset of SRS to the mapped CSI-RS in the update subset of CSI-RS. The UE may update the spatial reference(s) upon network confirmation of SRS spatial reference update. In other cases, the UE may update the spatial reference(s) without network confirmation. Note that the update of the spatial reference(s) for the update subset of SRS may be persistent until the next update, single-shot, or multi-shot. For a single-shot update, the WTRU may apply the (e.g., updated) spatial reference(s) to a single SRS transmission, without persistently updating the spatial reference(s). For subsequent SRS transmission(s), the WTRU may use the previous spatial reference(s). Similarly, for a multi-shot update, the WTRU may apply the (e.g., updated) spatial reference(s) to multiple SRS transmissions, wherein the number of transmissions may be configured or indicated to the WTRU, e.g., in the SRS-triggering DCI, SRS-activating DCI, or SRS-activating MAC CE.

About WTRU determination of transmission subset of SRS, the WTRU may determine a transmission subset of the configured set of SRS that is to be transmitted. The WTRU may determine the number of SRS in the transmission subset using any of a determination based on reported CSI-RS and a determination based on network indication/trigger.

About WTRU determination based on reported CSI-RS, the WTRU may determine the number of SRS in the transmission subset based on the reported CSI-RS by WTRU to the network. As non-limited examples, (i) the WTRU may determine the number of SRS to be equal to the number of reported CSI-RS to the network, (ii) the WTRU may determine the number of SRS to be equal to the number of SRS associated with the reported CSI-RS to the network. The number of SRS may be larger/smaller than the number of reported CSI-RS based on the configured association between SRS and CSI-RS, (iii) the WTRU may select one or more subsets of the configured SRS resource sets associated with the reported CSI-RS to the NW for transmission. In this case, the number of reported SRS is equal to the total number of SRS resources in the selected SRS resource sets for transmission, (iv) the WTRU may determine the number of SRS to be equal to the number of SRS with updated spatial references, e.g., the size of the update subset of SRS, (v) the WTRU may determine the CSI-RS in the reported subset of CSI-RS with a CSI-RS related metrics (SINR, RSRP, CQI, rank, etc.) above a threshold value, which may be configured or predefined. Then, the WTRU may determine the number of SRS to be equal to: the number of CSI-RS whose metric is greater than the threshold value, and/or the number of SRS associated with the CSI-RS whose metric is greater than the threshold value. Alternatively, the threshold value may be indicated to the WTRU and the WTRU may apply the same approach to determine the number of SRS in the transmission subset. (vi) The WTRU may determine the number of SRS to be the greatest number such that each SRS in the transmission subset correspond to different UL Tx beams.

The determined number of SRS may be limited to a maximum number, e.g., the number SRS in the configured set of SRS.

In some cases, the network might not be aware of the determined number, e.g., if it's based on the UL Tx beams corresponding to the SRS. The WTRU may indicate the number of SRS in the transmission subset to the network where such indication may be signaled through uplink control information (UCI) (e.g., along with the reported CSI-RS) over PUCCH or PUSCH. Also, the network may confirm or change this number and indicate the confirmation/change through any of or a combination of RRC configuration, MAC-CE, and DCI.

The WTRU may determine the number of SRS in the transmission subset based on triggering of transmission of a certain SRS resource set from the network where the SRS triggering can be done through any of a combination of RRC configuration, MAC-CE, and DCI. For example, the WTRU may determine the number of SRS to be equal to the number of SRS resources in a triggered SRS resource set.

The WTRU may determine the number of SRS in the transmission subset based on indication from the network. Such indication may be signaled through any of a combination of RRC configuration, MAC-CE, and DCI. For example, the indication can be carried by the DCI scheduling the PUSCH.

The network indication received by the WTRU may be a confirmation of all or subset of reported CSI-RS from the WTRU, e.g., the update subset of CSI-RS. For example, the network may send a bitmap of the reported CSI-RS by WTRU or sending one or more indices. Then, the WTRU may determines the number of SRS in the transmission subset to be equal to: (i) the number of confirmed CSI-RS by the NW, (ii) the number of SRS associated with the confirmed CSI-RS by the NW, or (iii) the total number of SRS resources included in SRS resource sets associated with the confirmed CSI-RS by the network.

The network indication received by the WTRU may be a value indicating the number of CSI-RS to be activated/confirmed and used as spatial references for SRS transmission (the WTRU determines which CSI-RS to be included in the update subset of CSI-RS based on the indicated number of CSI-RS by the network and preconfigured conditions, e.g., WTRU selects CSI-RS with highest reporting quantity such as RSRP, SINR, CSI, etc.). Then, the WTRU may determine the number of SRS in the transmission subset to be equal to: (i) the number of indicated CSI-RS by the NW, (ii) the number of SRS associated with the CSI-RS in the update subset of CSI-RS, or (iii) the total number of SRS resources included in SRS resource sets associated with the CSI-RS in the update subset of CSI-RS.

The network indication received by the WTRU may be a value indicating the number of SRS in the transmission subset, e.g., based on the reported CSI-RS to the network.

The WTRU may determine which SRS to include in the transmission subset based on the determined number of SRS in the transmission subset. In some cases, the WTRU may jointly determine the number and which SRS to include in the transmission subset.

The WTRU may determine the transmission subset of SRS (SRS in the transmission subset) using one or any combination of the following criteria. In a variation, the WTRU may select for the transmission subset the second, or third, etc., SRS based on one or any combination of the following criteria.

About properties-based determination, in an embodiment, the WTRU may select a subset of the configured SRS for transmission based on priorities for the configured SRS. For example, in case that the WTRU determines that a certain number of SRS need to be transmitted, the WTRU may select the SRS with the highest priorities. The priorities may be signaled to the WTRU through any of or a combination of RRC configuration, MAC-CE, and DCI.

About WTRU determination based on confirmed/indicated CSI-RS by network and association between SRS and CSI-RS, in an embodiment, the WTRU may select a subset of the configured set of SRS for transmission based on the confirmed subset of CSI-RS by the network. For example, the WTRU may select the SRS associated with the confirmed CSI-RS for transmission. In another embodiment, the WTRU may select a subset of the configured SRS for transmission based on the indicated CSI-RS by the NW (i.e., preferred CSI-RS by the NW). For example, the WTRU may select the SRS associated with the indicated CSI-RS by the network.

About WTRU determination based on SRS ID, in an embodiment, the WTRU may select a subset of the configured SRS for transmission based on their IDs. For example, the WTRU may be configured to select the SRS with the smallest/largest IDs. Such configurations may be signaled through any of or a combination of RRC configuration, MAC-CE, and DCI.

About WTRU determination based on ordinal position of SRS in SRS resource set, In an embodiment, the WTRU may select a subset of the configured SRS for transmission based on their ordinal position in the configured SRS list. For example, the WTRU may be configured to select the SRS according to the order in which they are listed in the SRS resource set configuration. Such configurations may be signaled through any of or a combination of RRC configuration, MAC-CE, and DCI.

About WTRU determination based on SRS with updated spatial references, in an embodiment, the WTRU may be configured to select the SRS with updated spatial references for transmission, e.g., the update subset of SRS. Such configurations may be signaled to the WTRU through any of or a combination of RRC configuration, MAC-CE, and DCI.

About WTRU determination based on SRS with different UL Tx beam, in an embodiment, the WTRU may be configured to select the SRS corresponding to different UL Tx beams for transmission.

About WTRU determination based on triggering of an SRS resource set, in an embodiment, the WTRU may be configured to select all SRS within a triggered SRS resource set for transmission. Such configurations may be signaled to the WTRU through any of or a combination of RRC configuration, MAC-CE, and DCI.

About WTRU determination based on time domain position of SRS, in an embodiment, the WTRU may select a subset of the configured SRS for transmission based on their time domain position. For example, the WTRU may select the SRS with lowest slot/symbol offsets. The WTRU may select the SRS assigned to early time symbols. The WTRU may select the SRS assigned to later time symbols. The WTRU may select the first SRS after a threshold in time, which may be in relation to a received DCI, e.g., the SRS-triggering DCI, or in relation to the end of a PUSCH transmission. The WTRU may omit SRS from the transmission subset that collide with another (e.g., higher-priority) signal/channel, and/or a symbol assigned to DL reception.

The time domain position of the SRS to be transmitted may be signaled to the WTRU through any of or a combination of RRC configuration, MAC-CE, and DCI.

About WTRU determination based on frequency domain position of SRS, in an embodiment, the WTRU may select a subset of the configured SRS for transmission based on their frequency domain allocation. For example, the WTRU may select the SRS carried over a certain number of resource block. The WTRU may select the SRS carried over a number of resource blocks within a configured range indicated by a minimum and maximum values. The WTRU may select the SRS carried over a number of resource blocks that is larger/smaller than a configured threshold. The WTRU may select the SRS carried over the resource blocks whose IDs are greater/smaller than a configured threshold. The WTRU may select the SRS configured with enabled frequency hopping. The WTRU may select the SRS configured with disabled frequency hopping. The WTRU may select the SRS configured with a certain number of hops. The WTRU may select the SRS configured with a number of hops above/below a threshold. The WTRU may select the SRS configured with a number of hops within a configured range indicated by a minimum and maximum values. The restrictions on the frequency domain position of the SRS to be transmitted may be signaled to the WTRU through any of or a combination of RRC configuration, MAC-CE, and DCI.

About WTRU determination based on comb configurations of SRS, in an embodiment, the WTRU may select a subset of the configured SRS for transmission based on their transmission comb configurations, e.g., the separation in number of sub-carriers between sub-carriers carrying SRS, the number of SRS sub-carriers per resource block, and/or the index of a first sub-carrier in a resource block that carries the SRS. For example, the WTRU may select the SRS configured with a certain comb offset and/or a certain comb spacing. The comb-related parameters for the SRS to be transmitted may be signaled to the WTRU through any of or a combination of RRC configuration, MAC-CE, and DCI.

About WTRU determination based on antenna port configurations of SRS, in an embodiment, the WTRU may select a subset of the configured SRS for transmission based on their antenna ports configurations. For example, the WTRU may select the SRS configured with a certain number of antenna ports, and or configured with a number of antenna ports above or below a configured threshold. The antenna port-related information of the SRS to be transmitted may be signaled to the WTRU through any of or a combination of RRC configuration, MAC-CE, and DCI.

About WTRU determination, based on SRS usage for DL CSI acquisition, in an embodiment, the WTRU may select the SRSs belonging to different SRS resource sets (i.e., with different Ids) whose usage is set to ‘antennaSwitching’. In another embodiment, the WTRU may select the SRSs based on their time domain position. For example, the WTRU may select SRSs in a way that allows a minimum guard period (e.g., minimum number of symbols) between the SRSs to be transmitted from different transmit antenna groups. The minimum guard period may be configured, predefined, or indicated to the WTRU through dynamic signaling.

About WTRU autonomous determination, the WTRU may determine the method by which it selects the SRS to be transmitted, e.g., based on the reported CSI-RS, based on the SRS with the smallest/largest IDs, based on their ordinal position in the SRS set, based on the update subset of SRS, based on the SRS time domain position, frequency domain position, comb, and/or antenna port configuration. Alternatively, the WTRU may freely select the SRS to be transmitted, e.g., randomly.

The WTRU shall indicate, to the network, the transmitted SRS where such indication may be signaled through UCI (e.g., along with the reported CSI-RS) over PUCCH or PUSCH.

In case of WTRU determination of the method for SRS selection, the network may confirm or may change this method and may indicate this decision through any of or a combination of RRC configuration, MAC-CE, and DCI.

About WTRU determination of resource(s) for SRS, after the WTRU is configured with a configured set of SRS, e.g., via SRS resource configuration(s), and offset configuration, the WTRU may receive a DCI (e.g., cither a CSI-triggering DCI or a CSI-activating DCI) triggering one or more CSI report(s). The WTRU may receive a MAC CE, e.g., CSI-activating MAC CE, that activates one or more CSI report(s). A CSI report may carry CSI comprising a reported subset of CSI-RS, etc.

In response to an SRS-triggering DCI (e.g., a DCI that triggers an aperiodic SRS transmission) is received from a gNB (e.g., the network), the WTRU may determine one or more SRS resource(s) for one or more SRS transmission(s), e.g., the transmission subset of SRS. As an illustrative example, an offset in slots is described below. However, the methods herein are equally applicable to offsets in other time units such as seconds, symbols, subslots, subframes, frames, etc . . . More particularly, the WTRU may determine a slot for an SRS transmission. The slot may be determined by the WTRU based on at least the offset value (e.g., indicating a slot offset) and a CSI reporting resource (e.g., either a PUSCH or a PUCCH).

It is noted that, there may be several alternative ways for a WTRU to derive an offset value for the SRS resource determination as following: (i) the offset value may be configured by a downlink RRC signaling, and the offset value may be indicated to be associated with the determined SRS resource; (ii) an offset value list containing multiple offset values may be configured by a downlink RRC signaling to be associated with the configured set of SRS resource, and one of offset value in the offset value list may be indicated by a DCI (e.g., the SRS-triggering DCI); and (iii) multiple offset value lists (each containing multiple offset values) may be configured by a downlink RRC signaling to be associated with the configured set of SRS resource. One of the multiple offset value lists may be activated (or indicated) by a MAC CE or by a DCI (e.g., SRS-triggering DCI). One of the offset values in one of the activated offset value lists may be indicated by the SRS-triggering DCI.

In a first embodiment, an aperiodic CSI reporting (triggered by a CSI-triggering DCI) on PUSCH in a first slot may be performed, and an aperiodic SRS transmission may have been triggered. The WTRU may need to determine a second slot having an SRS resource to be used for the aperiodic SRS transmission. In other words, the WTRU may determine a second slot, and may transmit the SRS on the SRS resource in the second slot. It is noted that, the aperiodic SRS transmission may be, but not limited to be, triggered by an SRS-triggering DCI. And it is also noted that, in one implementation, the aperiodic CSI reporting on PUSCH and the aperiodic SRS transmission may be triggered by same DCI, e.g., the CSI-triggering DCI is the same as the SRS-triggering DCI.

The second slot may be determined by the WTRU based on at least the first slot and an offset value associated with the aperiodic SRS transmission, wherein the offset value may indicate an offset in number of slots between the slot the aperiodic CSI report is transmitted and the slot the aperiodic SRS is transmitted. For example, the first slot is a slot n, and the second slot is slot n+offset value, wherein the n is a slot index. That is, the second slot is a slot which is offset value slot(s) after the first slot. In case the aperiodic CSI report is transmitted in multiple slots, e.g., due to PUSCH repetition, the second slot may be one of the slots on which the CSI report may be transmitted, e.g., the last slot.

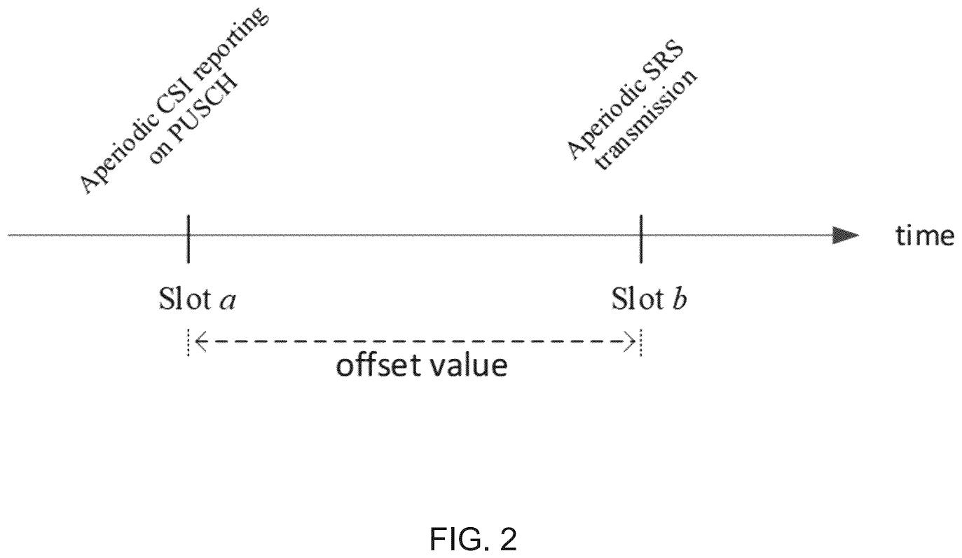

As an example, as shown at FIG. 2, a WTRU may be configured with a SRS resource configuration which is associated with offset configuration, and the offset configuration indicate a offset value in unit of slot. The WTRU may performs an aperiodic CSI reporting in slot a, and the WTRU may determine to perform an aperiodic SRS transmission by transmitting an SRS in slot b. Wherein the slot b is offset value slots after the slot a. That is, the WTRU may determine to perform the aperiodic SRS transmission in slot b which is determined based on the slot a and the offset value. In case of a CSI report is transmitted on multiple slots, e.g., due to PUSCH repetition and/or retransmission, the slot a may correspond to the slot of the last PUSCH transmission, e.g., the last repetition or retransmission.

In an example state of the art system, the WTRU may determine an SRS transmission time based on the time of receiving the corresponding SRS-triggering DCI and the offset value, e.g., the SRS transmission slot may be determined as the slot that comes the offset value slots after the slot of the DCI reception. However, in the methods described herein, the SRS transmission may be based on the CSI report. It may be beneficial if the network has received and decoded the CSI report before receiving the corresponding SRS. Therefore, it may be beneficial to use the CSI reporting time as the reference time for the SRS transmission time. For wide range of CSI report transmission times (e.g., on PUSCH), a single SRS offset value may be sufficient to guarantee network reception and decoding of a CSI report prior to the SRS transmission.

In a second embodiment, a periodic CSI reporting (triggered by a RRC configuration) on PUCCH or (activated) semi-persistent CSI reporting on PUCCH in a first slot is performed, and an aperiodic SRS transmission has been triggered by an SRS-triggering DCI which is received in a second slot. Each transmission of a periodic/semi-persistent CSI report corresponding to a CSI reporting setting may comprise a reported subset of CSI-RS, etc., wherein different transmitted CSI reports may comprise different reported subsets of CSI-RS, etc. The WTRU may need to determine a third slot having an SRS resource to be used for the aperiodic SRS transmission. In other words, the WTRU may determine a third slot, and transmits the SRS on the SRS resource in the third slot.

In a first alternative, the third slot may be determined by the WTRU based on at least the second slot and an offset value associated with the aperiodic SRS transmission. For example, the second slot is a slot n, and the third slot is slot n+offset value, wherein the n is a slot index which represented as an order of a slot in time domain. That is, the third slot may be a slot which is offset value slot after the second slot. The latest CSI report transmission may be the latest CSI report transmitted no later than the reception time (e.g., slot) of the SRS-triggering DCI.

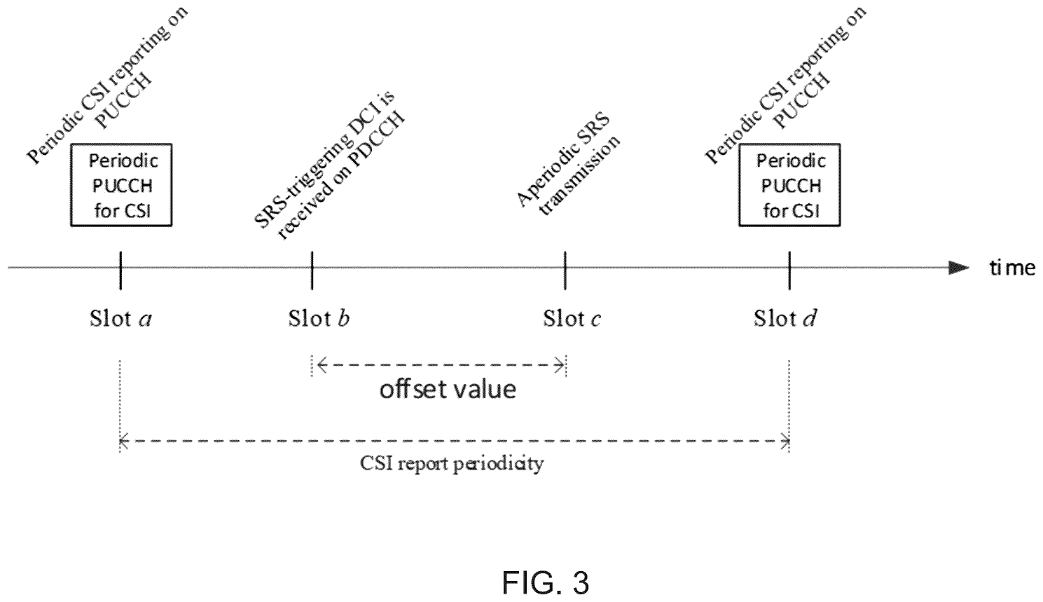

As an example, as shown at FIG. 3, a WTRU may be configured with a SRS resource configuration that is associated with an offset configuration, and the offset configuration may indicate an offset value in unit of slot. The WTRU may perform a periodic CSI reporting in slot a, an SRS-triggering DCI may be received in slot b, and the WTRU may determine to perform an aperiodic SRS transmission by using an SRS resource located in slot c. The slot c is offset value slots after the slot b. That is, the WTRU may determine to perform the aperiodic SRS transmission in slot c which is determined based on the slot b and the offset value.

In a second alternative, the third slot may be determined by the WTRU based on at least a fourth slot and an offset value associated with the aperiodic SRS transmission. The offset value may indicate an offset in number of slots between an upcoming slot (i.e., the fourth slot), after the second slot, having PUCCH resource for the periodic/semi-persistent CSI reporting and the slot the aperiodic SRS is transmitted. For example, the fourth slot may be a slot n, and the third slot may be slot n+offset value, wherein the n is a slot index. That is, the third slot may be a slot which is offset value slot after the fourth slot. In other words, the WTRU may receive an SRS-triggering DCI in a second slot, may transmit a CSI report on a PUCCH resource on a fourth slot that is after the second slot, and may transmit the SRS on the third slot that is after the fourth slot. The transmitted CSI report, e.g., comprising the subset of reported CSI-RS, may be the first CSI report transmission (corresponding to the particular considered periodic/semi-persistent CSI reporting setting) after the reception of the DCI.

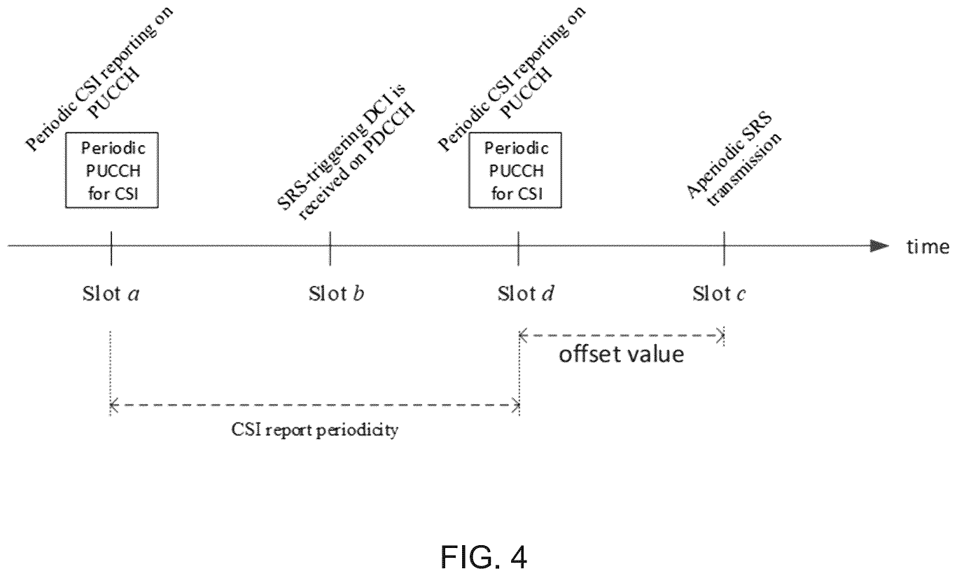

As an example, as shown at FIG. 4, a WTRU may be configured with an SRS resource configuration, with an offset configuration associated with the SRS resource configuration, and the offset configuration may indicate an offset value in unit of slot; and/or PUCCH resources for periodic CSI reporting, e.g., corresponding to a CSI reporting setting;

The WTRU may perform a periodic CSI reporting in slots PUCCH resources for the periodic CSI reporting, e.g., consecutive CSI reports in slot a and slot d. An SRS-triggering DCI may be received in slot b, and the WTRU may determine to perform an aperiodic SRS transmission by using an SRS resource located in slot c. The slot c may be an offset value slots after the slot d. That is, the WTRU may determine to perform the aperiodic SRS transmission in slot c which is determined based on the slot d and the offset value. Slot d may be represented as a slot which is the first slot with a periodic CSI report after the slot WTRU received the SRS-triggering DCI (i.e., slot b).

Note that examples herein for periodic CSI reporting may be equally applicable to semi-persistent CSI reporting that is activated. Also note that the WTRU may be configured with multiple periodic and/or semi-persistent CSI reporting settings. The methods herein may be applicable to SRS and CSI reports that are configured/indicated to be associated to be subject to the methods herein. For example, the WTRU may transmit other periodic/semi-persistent/aperiodic CSI reports on PUSCH and/or PUCCH that correspond to other CSI reporting settings for which legacy methods are configured to be used.

In a third alternative, the SRS-triggering DCI may indicate the WTRU to perform the aperiodic SRS transmission in a slot which may be determined based on either the slot the SRS-triggering DCI is received (e.g. the first alternative) or a first upcoming slot with CSI reporting on a PUCCH resource after the slot WTRU receiving the SRS-triggering (e.g. the second alternative). That is, the SRS-triggering DCI may indicate the WTRU to perform either the second alternative implementation or the first implementation. Specifically, the SRS-triggering DCI may indicate the WTRU to perform SRS transmission by using a SRS resource in a slot which is either offset value slots after the slot the SRS-triggering DCI is received or offset value slots after the first upcoming slot having PUCCH resource for the periodic CSI reporting after the slot UE receiving the SRS-triggering.

The WTRU may be configured with different offset values for the first and second alternatives, for an SRS. In other words, in case of the WTRU is indicated or determines to use the first alternative, the WTRU may use a first offset value for an SRS, while in case of the WTRU is indicated or determines to use the second alternative implementation, the WTRU may use a second offset value for an SRS.

The WTRU may be configured to use the first alternative for a first set of CSI reporting settings and the second alternative for a second set of CSI reporting settings, e.g., by a configuration parameter in the configuration of a CSI reporting setting. The WTRU may determine to use the first or second alternatives depending on if the CSI reporting is based on a CSI reporting setting in the first or second set of settings, respectively.

The WTRU may be configured to use the first alternative for a first set of SRS and the second alternative for a second set of SRS, e.g., by a configuration parameter in the configuration of an SRS resource set, an SRS trigger, etc. The WTRU may determine to use the first or second alternative implementation depending on if the triggered SRS belongs to the first or second set, respectively.

The WTRU may determine to use the first or second alternative based on the relative timing of slot a, b, and/or d and the offset value. For example, in case of the time difference between slot d and slot b plus the offset value is greater than a threshold, e.g., −1 slots, 0 slots, 1 slot, etc., the WTRU may use the first alternative, wherein the threshold may be configurable and/or depend on the CSI reporting period. Else, the WTRU may use the second alternative. In one example, the WTRU may select the alternative implementation (first or second) that gives the shortest time delay between the CSI reporting occasion comprising the reported subset of CSI-RS used for spatial reference update of SRS and the corresponding SRS transmission. For example, the WTRU may determine to use the first alternative if the delay between slot c and slot a according to the first implementation is smaller than the delay between slot c and slot d according to the second implementation, and vice versa.

In other words, in case of the potential SRS transmission time is close enough to the next CSI reporting occasion, the SRS transmission may be postponed to after the next CSI reporting occasion. This approach may have the benefit that the SRS spatial reference(s) may be based on a more recent reported subset of CSI-RS.

About transmission of SRS, as non-limited examples, (i) the WTRU may be triggered to transmit SRS through receiving DCI from the network, e.g., an SRS-triggering DCI; (ii) the WTRU may be triggered to transmit SRS through receiving confirmation of reported CSI-RS by WTRU from the network; (iii) the WTRU may transmit a periodic SRS, e.g., based on the configuration; and/or the WTRU may transmit activated semi-persistent SRS.

The WTRU may determine the number of SRS in the transmission subset and/or selects the SRS in the transmission subset. For each selected SRS in the transmission subset, the WTRU may determine the resources (time and frequency resources, e.g., REs) to carry the SRS. Also, for an SRS belonging to the update subset of SRS, the WTRU may determine the updated spatial reference of this SRS. The WTRU may form/set a corresponding Tx beam for each SRS in the transmission subset using the determined spatial reference(s). The WTRU may transmit it on the determined resources. In case of collision with other signals/channels, etc., the WTRU may omit the transmission of one or more of the SRS in the transmission subset.

In case of SRS for DL CSI acquisition, the WTRU may determine a first subset of SRS from the transmission subset of SRS to be transmitted from the first transmission antenna group. Then, when the WTRU switches to another transmission antenna group, it may determine the SRSs associated with this transmission antenna group. The WTRU may repeat the same procedure until it goes over all the transmission antenna group. At each iteration, after the WTRU determines the SRSs to be transmitted from a certain transmission antenna group, the WTRU may perform the following for each one of the determined SRS: (i) the WTRU may determine the resources (time and frequency resources, e.g., REs) to carry this SRS. If the SRS belonging to the update subset of SRS, (ii) the WTRU may determine the updated spatial reference of this SRS. The WTRU may form a Tx beam for this SRS in the transmission subset using the determined spatial reference. The WTRU may transmit the SRS(s) on the determined resources.

In an embodiment, the WTRU may be configured, by the network, through a downlink RRC signaling, with multiple SRS resources configurations, wherein: (i) each SRS resource configuration may indicate at least one SRS resource to be used by the WTRU for SRS transmission; and/or (ii) each SRS resource configuration may indicate one or more spatial references. Each of the one or more spatial references may indicate, to the WTRU, a reference signal to be used by the WTRU to determine a beam for SRS transmission on the corresponding SRS resource. More particularly, a spatial reference may indicate to the WTRU, a subset of the CSI-RS among the configured set of CSI-RS.

Following the reporting of a reported subset of CSI-RS by the WTRU, and (e.g., in some cases) an aperiodic SRS transmission has been triggered by a received SRS-triggering DCI, the WTRU may select one or more SRS resources (among the configured multiple SRS resource) for transmission. More particularly, one or more SRS resources associated with the subset of CSI-RS may be selected by the WTRU for SRS transmission. More particularly, the one or more SRS resources may be indicated to be associated with a spatial reference, with the spatial reference indicating the subset of CSI-RS.

About WTRU determination of spatial reference(s) for PUSCH, the WTRU may be indicated with one or more spatial reference(s) for PUSCH. Such indication may be signaled through any of a combination of RRC configuration, MAC-CE, and DCI. For example, the indication can be carried by the DCI scheduling the PUSCH, or the indication can be carried by a DCI that indicates the confirmation of the SRS spatial reference update.

In an embodiment, the indicated spatial reference(s) can be one or more SRS, e.g., the indicated subset of SRS. Based on the indication, e.g., in the DCI scheduling the PUSCH, the WTRU may determine the one or more SRS, which may be to be used as the spatial reference(s) for the PUSCH, from a subset of SRS configured to the WTRU. The WTRU may further determine the spatial reference for the indicated SRS based on the updated spatial reference for SRS. The WTRU may use the spatial reference(s), e.g., from the reported set of CSI-RS, and determined from the indicated SRS, for the PUSCH.

In another embodiment, the indicated spatial reference(s) can be one or more CSI-RS, e.g., the indicated subset of CSI-RS. The WTRU may (e.g., directly) determine the CSI-RS as the spatial reference(s) for the PUSCH. For example, the DCI that schedules a PUSCH may indicate one or more CSI-RS from the reported set of CSI-RS as the spatial reference for the PUSCH, e.g., each codepoint of the DCI field is associated with one or more of the reported CSI-RS. A codepoint may be associated with the one or more of the indexes of the reported subset of CSI-RS. The association between codepoint and CSI-RS in the reported set of CSI-RS may be based on the CSI-RS order in the reported set, e.g., the first codepoint is associated with the first reported CSI-RS, the second codepoint is associated with the second reported CSI-RS, etc.

The WTRU may (e.g., autonomously) determine the spatial reference(s) for PUSCH, e.g., according to the update subset of CSI-RS. This may be applied to the case when the PUSCH is semi-persistent (configured grant). As a non-limited example, the WTRU may determine a reported CSI-RS as the spatial reference(s) for the subsequent PUSCH transmission, once it reports the determined subset of CSI-RS or once it receives the confirmation from the gNB (e.g., network). The WTRU may determine one or more spatial reference(s) as the first one or more CSI-RS(s) reported in the corresponding CSI report, wherein the first CSI-RS(s) in the report may correspond to the highest metric(s), e.g., the highest reported RSRP(s).

About PUSCH transmission, the WTRU may transmit a PUSCH using the determined spatial reference. For example, the WTRU may use the determined spatial reference, e.g., SRS, CSI-RS, etc., to set the spatial domain transmit filter and to form a UL Tx beam for the PUSCH transmission.

About SRS for DL CSI acquisition, the WTRU may receive configurations from the network indicating how to receive a PDSCH, e.g., in case of UL/DL reciprocity-based operation. The WTRU may receive the configurations through any of or a combination of RRC configuration, MAC-CE, and DCI. As a non-limited example, the WTRU may be configured with a TCI state indicating one or more QCL source(s) (e.g., spatial reference(s)) for PDSCH reception. The QCL source(s) may comprise one or more of the transmitted SRS, SRS with updated spatial reference(s), indicated SRS, reported CSI-RS, confirmed/activated CSI-RS, indicated CSI-RS, etc . . . The WTRU may receive a DCI indicating which QCL source(s) to use for PDSCH reception. Alternatively, the WTRU may (e.g., autonomously) determine/decide the QCL source(s) to use for receiving the PDSCH.

As a first non-limited example, the WTRU may be indicated by the network to receive the PDSCH using SRS (e.g., SRS in the transmission set of SRS, SRS in the update subset of SRS, subset of the configured SRS, SRS in the indicated subset of SRS, etc.) as QCL source, e.g., spatial QCL source. The WTRU may apply the same beam (e.g., spatial filter) used for SRS transmission to receive a PDSCH in the DL. In some cases, the WTRU may use one or more of the spatial reference(s) (e.g., CSI-RS) of the SRS (e.g., one or more SRS from one of the subsets/sets of SRS mentioned above) as spatial QCL source(s) for a subsequent PDSCH.

As a second non-limited example, the WTRU may (e.g., autonomously) determine which to use for receiving the PDSCH. The WTRU may decide to receive the PDSCH using the beams (e.g., spatial filters) used for SRS in the transmission subset, SRS in the update subset of SRS, or the subset of the configured SRS, etc.

The following may apply both for the cases with reciprocity between UL and DL channels, without reciprocity, and/or with partial reciprocity: (i) the WTRU may be configured to receive the PDSCH using one or more of the reported CSI-RS as QCL source(s), the WTRU may apply the same spatial filter(s) used to receive the reported CSI-RS to receive the PDSCH; (ii) the WTRU may (e.g., autonomously) decide/determine to use the QCL (e.g., spatial filters) of CSI-RS to receive the PDSCH; (iii) the WTRU may be configured to receive the PDSCH using the confirmed CSI-RS, e.g., an indicated or update subset of CSI-RS, as QCL source(s). The WTRU may apply the same spatial filter used to receive the confirmed CSI-RS to receive the PDSCH; (iv) the WTRU may (e.g., autonomously) decide/determine to use the QCL (e.g., spatial filters) of confirmed CSI-RS by the NW to receive the PDSCH; (v) the WTRU may (e.g., autonomously) decide/determine to use the spatial filters of a subset of reported CSI-RS to receive the PDSCH.

In the following embodiment, the WTRU may update spatial references of SRS resources based on the WTRU's selection and reporting of a subset of CSI-RS, e.g., CSI-RS resource indicators (CRIs). Said embodiment allows the network to request the WTRU to jointly determine and report a subset of CSI-RS and update the SRS spatial reference(s) accordingly, with minimal additional signalling and latency. The network may use the report to turn off a subset of the sub-arrays during the WTRU's subsequent UL transmissions, or in the UL MU-MIMO scheduling procedure (e.g., different co-scheduled WTRUs transmit towards different parts of the TRP array), etc.

The embodiments described herein are applicable in a near field situation. The embodiments described herein may be equally applied in other situations, such as far field situations.

The following first embodiment may minimize the overhead and latency associated with a network-triggered update of spatial references for a set of SRS resources, wherein the updated spatial references are based on WTRU measurements on a (e.g., relatively large) set of CSI-RS. The purpose of the update of spatial references for SRS is to select a (relatively small) set of WTRU UL Tx beams that correspond to strong radio links towards sub-arrays. A strong radio link between a sub-array and a WTRU may be due to multiple factors, such as partial and time-varying obstruction of the TRP array, WTRU rotation resulting in the alignment/misalignment of instantaneous WTRU/sub-array beams pairs, etc.

The following first embodiment relates to a direct update of SRS spatial references.

In the first embodiment, at a first step, a WTRU may receive configuration for one or more of: (i) at least one CSI-RS resource set, containing a set of CSI-RS resources, (ii) at least one SRS resource set, each configured with at least one SRS resource with corresponding time (e.g., slot) offset(s), (iii) aperiodic CSI reporting.

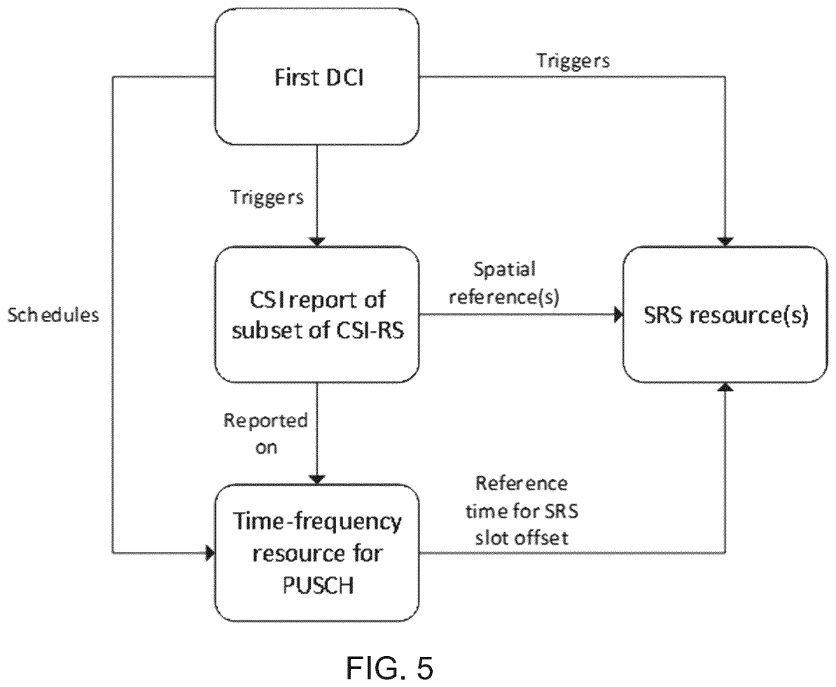

At a second step, as shown at FIG. 5, the WTRU may receive a first DCI carrying indication for one or more of: (i) a trigger for aperiodic CSI reporting of a subset of CSI-RS from the set of CSI-RS, (ii) scheduling information of a PUSCH resource for transmission of the CSI report, (iii) a trigger for transmission of SRS resource(s).

At a third step, the WTRU may perform a measurement (e.g., RSRP) to determine a subset of (e.g., the best) CSI-RS, e.g., based on a configured threshold.

At a fourth step, as shown at FIG. 5, the WTRU may transmit the CSI report on the scheduled PUSCH resource, wherein the CSI report may comprise one or more of: (i) information indicating the determined subset of the CSI-RS, e.g., CRI(s), (ii) information indicating the result of the performed measurement, e.g., measured RSRP, and (iii) information indicating an additional CSI, e.g., rank, precoding matrix indicator (PMI), etc., corresponding to the indicated CSI resource.

At a fifth step, the WTRU may determine a time (e.g., slot) for transmission of the triggered SRS resource(s) by adding the configured SRS time (e.g., slot) offset(s) to a time (e.g., slot) reference, e.g., the time (e.g., slot) of the scheduled PUSCH resource. The PUSCH resource (instead of the PDCCH carrying the first DCI) may act as a reference time for the SRS time (e.g., slot) offset(s), since the network should decode the PUSCH and obtain the CSI report prior to the reception of the SRS resource(s), in order to determine which spatial reference(s) the WTRU will use for the SRS resource(s).

At a sixth step, as shown at FIG. 5, the WTRU may transmit the triggered SRS resource(s) at the determined time for transmission using the reported subset of the CSI-RS as spatial reference(s).

In a second embodiment, wherein spatial reference update is based on configured association with CSI reporting setting, at a first step, the WTRU may be configured with: (i) a set of CSI-RS, (ii) a CSI reporting setting, comprising configuration of reporting of a subset of CSI-RS from the set of CSI-RS, (iii) a set of SRS resource(s), and (iv) an association between the set of SRS resource(s) and the CSI reporting setting. At a second step, the WTRU may determine a subset of the set of CSI-RS. At a third step, the WTRU may transmits a CSI report corresponding to the CSI reporting setting, indicating the determined subset of CSI-RS. At a fourth step, the WTRU may update spatial reference(s) for the set of SRS resource(s) based on the reported subset of CSI-RS. At a fifth step, the WTRU may transmit the set of SRS resource(s) based on the updated spatial reference(s).

In a third embodiment, wherein spatial reference update is based upon network confirmation, at a first step, the WTRU may be configured with (i) a set of CSI-RS, (ii) a set of SRS resource(s), and (iii) a CSI reporting setting, comprising a CSI reporting setting Id and a configuration of reporting of a subset of CSI-RS from the set of CSI-RS. At a second step, the WTRU may determine a subset of the CSI-RS. At a third step, the WTRU may transmit a CSI report based on the CSI reporting setting, wherein the CSI report comprises information indicating the determined subset of the CSI-RS. At a fourth step, the WTRU may receive a DCI, wherein: (i) the DCI may trigger transmission of the set of SRS resource(s), (ii) the DCI may comprise information indicating a CSI reporting setting Id, based on which the WTRU shall determine spatial reference(s) for the subset of SRS resource(s), (iii) the DCI may comprise information indicating a subset of the reported CSI-RS and/or a subset of the SRS resource(s) for spatial reference update. At a fifth step, the WTRU may determine spatial reference(s) of the (sub)set of SRS resource(s) based on the (sub)set of reported CSI-RS. At a sixth step, the WTRU may transmit the triggered SRS resource(s) based on the determined spatial reference(s).

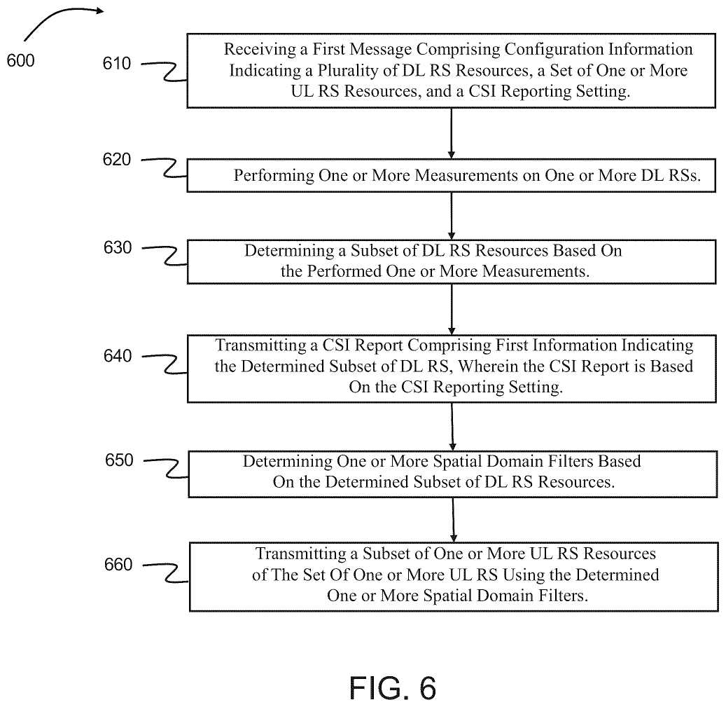

Referring to FIG. 6, an example of a method 600, implemented in a WTRU, for selecting an uplink Tx beam for transmission may comprise a step wherein the WTRU may receive 610 a first message comprising configuration information indicating a plurality of downlink reference signal (DL RS) resources, a set of one or more uplink reference signal (UL RS) resources, and a channel state information (CSI) reporting setting. The method 600 may further comprise a step wherein the WTRU may perform 620 one or more measurements on one or more DL RSs. Performing the one or more measurements may comprise performing any of a DL RS received power (DL RSRP) measurement, and signal to interference and noise power ratio (SINR) on the one or more DL RSs. The method 600 may further comprise a step wherein the WTRU may determine 630 a subset of DL RS resources based on the performed one or more measurements. The method 600 may further comprise a step wherein the WTRU may transmit 640 a CSI report comprising first information indicating the determined subset of DL RS, wherein the CSI report is based on the CSI reporting setting. The CSI report may comprise second information indicating one or more results of the one or more measurements on the one or more DL RSs. The method 600 may further comprise a step wherein the WTRU may determine 650 one or more spatial domain filters (e.g., UL Tx beams) based on the determined subset of DL RS resources; and a step wherein the WTRU may transmit 660 a subset of one or more UL RS resources of the set of one or more UL RS using the determined one or more spatial domain filters.

The method 600 may comprise a step wherein the WTRU may determine the subset of one or more UL RS resources based on the determined subset of DL RS resources. The method 600 may comprise a step wherein the WTRU may determine the subset of one or more UL RS resources based on the determined one or more spatial domain filters.

The method 600 may comprise a step wherein the WTRU may receive a downlink control information (DCI) comprising third information indicating a trigger for CSI reporting, and the transmitting the CSI report is triggered by the DCI. The method 600 may comprise a step wherein the WTRU may receive the DCI comprising fourth information indicating a trigger for transmission of the subset of one or more UL RS resources, and the transmitting the subset of one or more UL RS resources is triggered by the DCI.

The method 600 may comprise a step wherein the WTRU may receive the DCI comprising scheduling information of a physical uplink shared channel (PUSCH) resource for transmission of the CSI report; and a step of transmitting the CSI report on the scheduled PUSCH resource. The set of one or more UL RS resources may be respectively associated with one or more time offsets, and the scheduling information may comprise a PUSCH transmission time corresponding to (e.g., associated with) the scheduled PUSCH resource, such that the method 600 may comprise a step wherein the WTRU may determine, based on the one or more time offsets, one or more UL RS transmission times respectively associated with the subset of one or more UL RS resources, wherein the determination of the one or more UL RS transmission times comprises adding the one or more time offsets to the PUSCH transmission time; and a step wherein the WTRU may transmit the subset of one or more UL RS resources in the determined respectively one or more UL RS transmission times using the determined spatial domain filters.

The configuration information may further indicate an association between the CSI reporting setting and the set of UL RS resources, and the transmitting the subset of one or more UL RS resources may be based on the association between the CSI reporting setting and the set of UL RS resources.

The configuration information may further indicate an association between the CSI reporting setting and the set of UL RS resources, such that the method 600 may comprise a step wherein the WTRU may transmit the CSI report comprising the first information indicating the determined subset of DL RS, wherein the CSI report is based on the associated CSI reporting setting. The method 600 may further comprise a step wherein the WTRU may transmit the subset of one or more UL RS resources of the set of the associated one or more UL RS using the determined one or more spatial domain filters.

The UL RS resources may be sounding reference signal (SRS) resources. The DL RS resources may be channel state information reference signal (CSI-RS) resources.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method, implemented in a wireless transmit/receive unit (WTRU), comprising
receiving a first message comprising configuration information indicating a plurality of downlink reference signal (DL RS) resources, a set of one or more uplink reference signal (UL RS) resources, and a channel state information (CSI) reporting setting;
performing one or more measurements on one or more DL RSs;
determining a subset of DL RS resources based on the performed one or more measurements;
transmitting a CSI report comprising first information indicating the determined subset of DL RS resources, wherein the CSI report is based on the CSI reporting setting;
determining one or more spatial domain filters based on the determined subset of DL RS resources; and
transmitting a subset of one or more UL RS resources of the set of one or more UL RS resources using the determined one or more spatial domain filters.

2. The method of claim 1, comprising:
receiving a downlink control information (DCI) comprising second information indicating a trigger for CSI reporting, and the transmitting the CSI report is triggered by the DCI.

3. The method of claim 1 comprising:
receiving a DCI comprising third information indicating a trigger for transmission of the subset of one or more UL RS resources, and the transmitting the subset of one or more UL RS resources is triggered by the DCI.

4. The method of claim 1, wherein the CSI report comprises fourth information indicating one or more results of the one or more measurements on the one or more DL RSs.

5. The method of claim 1 comprising:
receiving a DCI comprising scheduling information of a physical uplink shared channel (PUSCH) resource for transmission of the CSI report; and
transmitting the CSI report on the scheduled PUSCH resource.

6. The method of claim 5, wherein the set of one or more UL RS resources are respectively associated with one or more time offsets, and wherein the scheduling information comprises a PUSCH transmission time corresponding to the scheduled PUSCH resource, the method comprising:
determining, based on the one or more time offsets, one or more UL RS transmission times respectively associated with the subset of one or more UL RS resources, wherein determining the one or more UL RS transmission times comprises adding the one or more time offsets to the PUSCH transmission time; and
transmitting the subset of one or more UL RS resources in the determined respectively one or more UL RS transmission times using the determined spatial domain filters.

7. The method of claim 1, wherein performing the one or more measurements comprises performing any of a DL RS received power (DL RSRP) measurement, and signal to interference and noise power ratio (SINR) on the one or more DL RSs.

8. The method of claim 1, wherein the configuration information further indicates an association between the CSI reporting setting and the set of UL RS resources, the method comprising:
transmitting the CSI report comprising first information indicating the determined subset of DL RS, wherein the CSI report is based on the associated CSI reporting setting;
determining the one or more spatial domain filters based on the determined subset of DL RS resources; and
transmitting the subset of one or more UL RS resources of the set of the associated one or more UL RS using the determined one or more spatial domain filters.

9. The method of claim 1, comprising determining the subset of one or more UL RS resources based on the determined subset of DL RS resources.

10. The method of claim 1, comprising determining the subset of one or more UL RS resources based on the determined one or more spatial domain filters.

11. The method of claim 1, wherein the UL RS resources are sounding reference signal (SRS) resources.

12. The method of claim 1, wherein the DL RS resources are channel state information reference signal (CSI-RS) resources.

13. A wireless transmit/receive unit (WTRU) comprising a processor, a transmitter, a receiver and a memory, configured to:
receive a first message comprising configuration information indicating a plurality of downlink reference signal (DL RS) resources, a set of one or more uplink reference signal (UL RS) resources, and a channel state information (CSI) reporting setting;
perform one or more measurements on one or more DL RSs;
determine a subset of DL RS resources based on the performed one or more measurements;
transmit a CSI report comprising first information indicating the determined subset of DL RS resources, wherein the CSI report is based on the CSI reporting setting;
determine one or more spatial domain filters based on the determined subset of DL RS resources; and
transmit a subset of one or more UL RS resources of the set of one or more UL RS resources using the determined one or more spatial domain filters.

14. The WTRU of claim 13 configured to receive a downlink control information (DCI) comprising second information indicating a trigger for CSI reporting, and the transmitting the CSI report is triggered by the DCI.

15. The WTRU of claim 13 configured to receive a DCI comprising third information indicating a trigger for transmission of the subset of one or more UL RS resources, and the transmitting the subset of one or more UL RS resources is triggered by the DCI.

16. The WTRU of claim 13, wherein the CSI report comprises fourth information indicating one or more results of the one or more measurements on the one or more DL RSs.

17. The WTRU of claim 13 configured to:
receive a DCI comprising scheduling information of a physical uplink shared channel (PUSCH) resource for transmission of the CSI report; and
transmit the CSI report on the scheduled PUSCH resource.

18. The WTRU of claim 17, wherein the set of one or more UL RS resources are respectively associated with one or more time offsets, and wherein the scheduling information comprises a PUSCH transmission time corresponding to the scheduled PUSCH resource, configured to:
determine, based on the one or more time offsets, one or more UL RS transmission times respectively associated with the subset of one or more UL RS resources, wherein determining the one or more UL RS transmission times comprises adding the one or more time offsets to the PUSCH transmission time; and
transmit the subset of one or more UL RS resources in the determined respectively one or more UL RS transmission times using the determined spatial domain filters.

19. The WTRU of claim 13, wherein performing the one or more measurements comprises performing any of a DL RS received power (DL RSRP) measurement, and signal to interference and noise power ratio (SINR) on the one or more DL RSs.

20. The WTRU of claim 13, wherein the configuration information further indicates an association between the CSI reporting setting and the set of UL RS resources, configured to:
transmit the CSI report comprising first information indicating the determined subset of DL RS, wherein the CSI report is based on the associated CSI reporting setting;
determine the one or more spatial domain filters based on the determined subset of DL RS resources; and
transmit the subset of one or more UL RS resources of the set of the associated one or more UL RS using the determined one or more spatial domain filters.

21. The WTRU of claim 13 configured to determine the subset of one or more UL RS resources based on the determined subset of DL RS resources.

22. The WTRU of claim 13 configured to determine the subset of one or more UL RS resources based on the determined one or more spatial domain filters.

23. The WTRU of claim 13, wherein the UL RS resources are sounding reference signal (SRS) resources.

24. The WTRU of claim 13, wherein the DL RS resources are channel state information reference signal (CSI-RS) resources.
